(19) United States
(12) Patent Application Publication
(10) Pub. No.: US 2026/0312751 A1
(43) Pub. Date: Oct. 8, 2026

(54) Coreset 0 Puncturing

(71) Applicant: Telefonaktiebolaget LM Ericsson (publ), Stockholm (SE)

(72) Inventors: Gerardo Agni Medina Acosta, Märsta (SE); Kittipong Kittichokechai, Järfälla (SE); Mirza Uzair Baig, Märsta (SE); Keerthi Kumar Nagalapur, Göteborg (SE)

(21) Appl. No.: 19/481,335

(22) PCT Filed: May 3, 2024
(86) PCT No.: PCT/EP2024/062323

§ 371 Date: Nov. 4, 2025

Related U.S. Application Data
(60) Provisional application No. 63/464,279, filed on May 5, 2023.

(51) Int. Cl. H04L 5/00

(52) U.S. Cl. CPC H04L 5/0044

(57) ABSTRACT

A UE receives a first physical channel from a network node. Further, the UE determines a location of a set of a plurality of Physical Resource Blocks, PRBs, corresponding to a Control Resource Set Number 0, CORESET 0, on which a second physical channel is to be mapped and determining a first subset of PRBs of the set of PRBs of CORESET 0, on which the second physical channel is to be received, wherein the first subset of PRBs is within a maximum transmission bandwidth, and wherein all the PRBs outside the first subset of PRBs are punctured such that the second physical channel is not received on those punctured PRBs. The first subset is determined based on information comprising at least one of:—a location of the first subset of PRBs from the set of PRBs of CORESET 0;—a starting location of the first subset of PRBs;—a length, L, of the first subset of the PRBs;—a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

### TECHNICAL FIELD

The present disclosure relates to a wireless communication system and, more specifically, operation in a wireless communication system when using puncturing of CORESET #0.

### BACKGROUND

At 3GPP (3rd Generation Partnership Project) meeting RAN #94-e, a new Work Item (WI) on “NR support for dedicated spectrum less than 5 MHz for FR1” was approved (see 3GPP contribution RP-213603, “NR support for dedicated spectrum less than 5 MHz for FR1,” 3GPP TSG RAN meeting #94e, Electronic Meeting, Dec. 6-17, 2021). The Work Item Description WID relates to the use cases of Future Railway Mobile Communication System (FRMCS), utilities, and public safety for which the following has been highlighted as part of the WID's justification, as shown in the following excerpt from RP-213603:

“Rail Communication in Europe is used for operational purposes to ensure the safety of millions of rail passengers. The Future Railway Mobile Communication System (FRMCS) forms the basis for digitizing rail operations with the aim of increasing train path utilization and improving punctuality. For the use of the harmonized 900 MHz spectrum block (2×5.6 MHz FDD), for a period of approximately 10 years from 2025 onwards, constraints stem from the need to operate in parallel FRMCS and the currently deployed and operational GSM-R system. Depending on the traffic volume and location, GSM-R requires a significant portion of the 4 MHz according to the GSM-R band definition, e.g., according to 3GPP TS (Technical Specification) 45.005 V17.0.0 (2022-03), although this is expected to reduce as traffic migrates from GSM-R to FRMCS. Consequently, possibilities in 5G NR to operate in bandwidths <5 MHz (e.g., from around 3 MHz upwards) would enable parallel operation of FRMCS and GSM-R and massive infrastructure reuse.

Around 1 million rail vehicles are registered in Europe. The vehicles, mostly closed train compositions with two driving heads, which are already equipped with GSM-R today, usually have 2 GSM-R UEs up to 6 UEs when European Train Control System is used. This group of vehicles makes up around 10%. It is expected that a second group of rail vehicles (approx. 40%) will be equipped with FRMCS capabilities during the course of the next decade. Upgrading the remaining vehicles with FRMCS is done in a broader schedule. The responsible authorities and organizations in Europe have set the start of the migration from GSM-R to FRMCS for 2025.

The provision of simultaneous use of the 2×5.6 MHz FDD in the 900 MHz frequency band and the associated provision of bandwidths less than 5 MHz for 5G NR thus has a key function in order to be able to start the migration from GSM-R to FRMCS in Europe.

In summary, FRMCS plays a key role in the automation of rail operations. It is anticipated that this will lead to a significant improvement in route utilization and thus also contribute to the reduction of greenhouse gases.

For Public Protection and Disaster Relief (PPDR), 2×3 MHz FDD in band 28 has been identified in Europe.

NR specifications starting in Rel-15 defined a minimum bandwidth of 5 MHz channels. Although NR can support multiple channel bandwidths due to the flexible numerology implementation, channel bandwidths smaller than this are currently not supported in NR. The minimum PRB size in multiples of 4 and the size of the PBCH are the determining factors in not being able to scale to smaller than 5 MHz channel bandwidths.”

In line with the WID's justification, the following Rel-18 objectives for RAN1 were defined as described in RP-213603:

The following objectives shall be included for dedicated FDD (Frequency Division Duplex) spectrum in FR1:
“Identify and specify necessary changes to NR (New Radio) physical layer with minimum specification impact to operate in spectrum allocations from approximately 3 MHz up to below 5 MHz [RAN1]:
   Restrict to subcarrier spacing of 15 kHz and the use of normal cyclic prefix.
   For SSB (Synchronization Signal Block):
      Reuse PSS/SSS specification without puncturing.
      PBCH based on current design
   Identify and specify necessary minimum changes to PDCCH (Physical Downlink Control Channel), CSI-RS/TRS, PUCCH, and PRACH for functional support based on existing design, without optimization.”

The WID explicitly mentions a set of physical channels, in particular SSB (synchronization Signal Block), PDCCH (Physical Downlink Control Channel), PUCCH (Physical Uplink Control Channel), and PRACH (Physical Random Access Channel) and signals, in particular CSI-RS (Channel State Information Reference Signals)/TRS (Tracking Reference Signals) that need to be investigated as to identify and specify necessary changes on them to operate in spectrum allocations from approximately 3 MHz up to below 5 MHz.

Moreover, in 3GPP meeting RAN #99 the following guideline was provided (see 3GPP contribution RP-230780, “Response to LS from RAN1 on transmission bandwidths for NR on dedicated spectrum less than 5 MHz,” 3GPP TSG RAN #99, Rotterdam, Netherlands, 20-23 Mar. 2023, in the following shortly denoted as “reply”):

“1. Overall Description:

RAN would like to thank RAN WG1 for their LS on transmission bandwidths for NR on dedicated spectrum less than 5 MHz.

RAN Plenary has discussed the possible transmission bandwidth options for 3 MHz and 5 MHz channel bandwidths for the spectrum allocations on the bands of interest in this work item, and concluded the following:
For the 3 MHz channel bandwidth in band n100 (max channel utilization 15 PRBs as already agreed in RAN1/RAN4):
   PBCH transmission bandwidth is 12 PRBs
   CORESET #0 transmission bandwidth is to be decided by RAN1.
RAN1 is requested to consider whether the above also applies for other bands with 3 MHz channel bandwidth, or whether the PBCH transmission bandwidth is 15 PRBs for such bands.
For the 5 MHz channel bandwidth:
   PBCH transmission bandwidth is 20 PRBs
   CORESET #0 transmission bandwidth is to be decided by RAN1
Other details (including sync raster details) are to be progressed in the WGs.

Based on the reply, scenarios under the scope of the WI of RP-213603 are illustrated in FIG. 1.

Further, based on the reply, it was mentioned that in the initial phase of migration, the railway infrastructure managers need to maintain the network quality level of GSM-R while reducing the available bandwidth for GSM-R channels (see 3GPP contribution RP-230189, “UIC response to LS from RAN1 on transmission bandwidths for NR on dedicated spectrum less than 5 MHz”, 3GPP TSG-RAN #99, Rotterdam, Netherlands, 20-23 Mar. 2023). the reply also stated that for the case “up to below 5 MHz”, the ideal situation depending on FRMCS traffic needs would be to allow any number of RBs between 15 and 20 but that would also raise the complexity of the overall design supported in 3GPP.

Thus, as part of the WI of RP-213603,” a new channel bandwidth of 3 MHz was defined, whereas sub-3 MHz and sub-5 MHz use-cases will be supported through confining UL (uplink) and DL (downlink) transmissions within and without fully utilizing the maximum transmission bandwidths of the nominal channel bandwidths for 3 MHz and 5 MHz respectively.
Under the framework of a 3 MHz channel bandwidth, two scenarios are supported: 1) Scenario A where UL/DL transmissions span in frequency domain up to 15-PRBs (Physical Resource Blocks), and 2) Scenario B where UL/DL transmissions span in frequency domain up to 12 PRBs.
Under the framework of a 5 MHz channel bandwidth, two scenarios are supported: 1) Scenario A where UL/DL transmissions span in frequency domain up to 25-PRBs, and 2) Scenario B where UL/DL transmissions span in frequency domain up to 20 PRBs.

Once the scenarios under the scope of this WI have been described, below we provide an overview of the physical channels and signals mentioned in the WID.

### 1) SSB

The most fundamental aspects of SSB can be summarized as follows (see 3GPP TS TS 38.211, “NR; Physical channels and modulation” V17.3.0 (2022-09), 3GPP TS 38.213, “NR; Physical layer procedures for control” V17.3.0 (2022-09), 3GPP TS 38.213, “NR; Physical layer procedures for control” V17.2.0 (2023-06)):
   An SSB contains the Primary Synchronization Signal (PSS), Secondary Synchronization signal (SSS), Physical Broadcast channel (PBCH) along with the Demodulation Reference Signal (DM-RS).
      BCH (Broadcast Channel) carries the Master Information Block (MIB)
      The MIB includes the system information (SI) as indicated in FIG. 3 (see 3GPP TS 38.331, “NR; Radio Resource Control (RRC); Protocol specification” 17.1.0 (2022-06).
   In frequency domain, one SSB block occupies 20 contiguous resource blocks (RBs) which is equivalent to 240 subcarriers, as illustrated in FIG. 3. In time domain, one SSB block spans over 4 OFDM (Orthogonal Frequency Division Multiplexing) symbols. Among the four symbols, one symbol is for PSS, one symbol is for SSS, and 2 symbols are for PBCH. Specifically, PSS occupies the first OFDM symbol of SSB and spans over 127 subcarriers. SSS is located in the third OFDM symbol of SSB and spans over 127 subcarriers. The total number of resource elements (REs) used for PBCH transmission per SSB is 576. There are, however, 113 unused subcarriers in the first symbol, and 17 unused subcarriers in the thirds symbol, as shown in FIG. 1. Therefore, there are 130 unused resource elements (REs) within an SSB. In the current NR design, the complex-valued symbols corresponding to these unused REs are set to zero. One or more SSBs can be transmitted per SS (Synchronization Signal) burst according with the table illustrated in FIG. 4, which indicates the maximum number of SSBs per SS burst depending on SCS (subcarrier spacing) and carrier frequency.
   “Cell search” for “SS/PBCH block” accounting for different carrier frequencies and subcarrier spacings:
      Within one half-frame there are several occurrences of SSBs.
      The SSBs can be located in the first or second half of the frame as indicated via MIB.
      One or multiple SSBs (i.e., a group of occurrences) compose an SS burst.
      The SS burst periodicity can be 5 ms, 10 ms, 20 ms, 40 ms, 80 ms, or 160 ms.

The legacy NR SSB structure using a SCS of 15 kHz results in ~3.6 MHz occupancy in the frequency-domain, hence either applying a puncturing technique or a SSB structure modification will be needed for fulfilling the WID's objective.

3GPP discussed the above and in 3GPP meeting RAN1 #111 the following agreements were reached touching upon SSB:
For evaluation and analysis, it can be assumed that the UE could know which RBs are used for SSB transmission after PSS/SSS is detected for evaluation and analysis.
   For transmission bandwidths of <5 MHz for 3 MHz and 5 MHz channel bandwidth, a subset of PRBs of 20-PRB PBCH are used for PBCH transmission if the transmission BW of a channel is less than 20 PRBs. It should be further studied which PRBs are used and how to use the PRBs, and PRBs for PSS/SSS are not punctured.
   It is to be studied whether and how to recover PBCH detection performance for transmission bandwidths of <5 MHz for 3 MHz and 5 MHz channel bandwidth. The following options are considered:
      Option 1: Power boosting
      Option 2: Multiple PBCH receptions
      Option 3: PBCH remapping
      Option 4: PBCH payload reduction
      Option 5: PBCH rate matching around the punctured PRBs
      Option 6: no enhancement specified.

### 2) PDCCH

Prior to Rel-18, PDCCH for NR overall has the following characteristics:
PDCCH is mapped to a specific CORESET (Control Resource Set).
PDCCH occupies 1, 2, 4, 8, or 16 Control Channel Elements (CCEs).
   1 CCE corresponds to 6 Resource Element Groups (REGs).
      1 REG equals to 1 Resource Block (RB) in 1 OFDM symbol.
The CCE-to-REG mapping depends on a specific time-frequency resource configuration of a CORESET that spans up to 3 symbols in the time-domain.
The CCE-to-REG mapping can utilize one of the two following approaches:
   Interleaved mapping (Always applied in CORESET 0)
   Non-Interleaved mapping

PDCCH is mapped to a specific CORESET. Thus, the highest “Aggregation level” that can be used depends on the resource blocks in the frequency domain according with

$$“ {N}_{RB}^{CORESET} ”$$

and symbols

$$“ {N}_{symb}^{CORESET} ”$$

in the time domain configured for a CORESET.

### 3) CORESET 0

In frequency domain, a CORESET can span over one or multiple chunks of 6 RBs. For CORESETs other than CORESET 0, multiple chunks of 6 RBs can be either contiguous or non-contiguous, and the starting RB of a CORESET is determined based on clause 10.1 in 3GPP TS 38.211 V17.3.0. On the other hand, CORESET 0 (which is configured and used during the initial access), can only have 24, 48, or 96 RBs.

For CORESET 0 configured by the ControlResourceSetZero IE:

$${N}_{RB}^{CORESET} and {N}_{symb}^{CORESET}$$

are defined by clause 13 of 3GPP TS 38.213 V17.3.0;
the UE may assume interleaved mapping
L=6; This variable refers to the REG bundle size.
R=2; This variable refers to the Interleaver size.

$${n}_{shift} = {N}_{ID}^{cell} ;$$

the UE may assume normal cyclic prefix when CORESET 0 is configured by MIB or SIB1 (System Information Block Type 1);
the UE may assume the same precoding being used within a REG bundle.

Moreover, CORESET 0 must be contiguous in frequency domain and only supports interleaved CCE-to-REG mapping.
REG bundle i is defined as REGs {iL,iL+1, . . . , iL+L−1} where L is the REG bundle size,

$$i = 0 , 1 , … , {N}_{REG}^{CORESET} / L - 1 , and {N}_{REG}^{CORESET} = {N}_{RB}^{CORESET} {N}_{symb}^{CORESET}$$

is the number of REGs in the CORESET.
For interleaved CCE-to-REG mapping, L∈{2,6} for

$${N}_{symb}^{CORESET} = 1 and L ∈ \{ {N}_{symb}^{CORESET} , 6 \}$$

for

$${N}_{symb}^{CORESET} ∈ \{ 2 , 3 \} .$$

The interleaver is defined by

$$f ( x ) = ( rC + c + {n}_{shift} ) mod ( {N}_{REG}^{CORESET} / L )$$

$$x = cR + r$$

$$r = 0 , 1 , ... , R - 1$$

$$c = 0 , 1 , ... , C - 1$$

$$C = {N}_{REG}^{CORESET} / ( LR )$$

Another important aspect to consider is that there is a close connection between the location in frequency of CORESET 0 and SSB, since CORESET 0 has an offset (i.e., “Offset (RBs)”) defined with respect to “K_{ssb} offset” that in turn uses SSB as reference as illustrated in FIG. 5.

The puncturing on PDCCH in CORESET 0 will be determined by the puncturing applied on SSB, and the offset parameters “k_{ssb}” and “Offset (RBs)”.

In 3GPP meeting RAN1 #111, the following agreements were reached touching upon PDCCH and CORESET 0:

For CORESET 0 configuration for transmission bandwidths <5 MHz for 3 MHz and 5 MHz channel bandwidth, following options are for study:
Option 1: Existing configuration table for 15 kHz SCS, 5 MHz minimum channel bandwidth (i.e., table 13-1 in 3GPP TS 38.213 17.3.0) is reused for configuration
Option 2: A new CORESET #0 configuration table is to be introduced for the configuration.

It is to be studied whether and how to recover PDCCH detection performance of CORESET #0 for transmission bandwidths of <5 MHz for 3 MHz and 5 MHz channel bandwidth. The following options are considered:
Option1: Power boosting
Option 2: Non-interleaved CCE-to-REG mapping
Option 3 A new interleaver to ensure PDCCH is fully mapped in the spectrum
Option 4: New aggregation level(s) for fit in the spectrum
Option 5: PDCCH rate matching
Option 6.: no enhancement specified.

### 4) PUCCH

PUCCH in NR prior to Rel-18 supports multiple formats (i.e., 0, 1, 2, 3, and 4), for which the frequency-domain utilization is either 1 PRB or “1 . . . 16” depending on the format (see 3GPP TS 38.211 V17.3.0 and 3GPP TS 38.331 V17.1.0). The flexibility of the PUCCH configurations in the frequency-domain suggest that in principle “spectrum allocations from approximately 3 MHz up to below 5 MHz” can be supported with no impact on PUCCH.

As regards the PUCCH, in 3GPP meeting RAN1 #111 it was concluded that no enhancements are needed for PUCCH to support transmission bandwidths of <5 MHz for 3 MHz and 5 MHz channel bandwidth and that the necessity for PUCCH frequency hopping disabling is for further study.

### 5) PRACH

To support “spectrum allocations from approximately 3 MHz up to below 5 MHz,” if according to the WID's guideline SCS is to be 15 KHz for PRACH, then PRACH preamble formats in Table 6.3.3.1-2 of 3GPP TS 38.211 apply (see 3GPP TS 38.211 V17.3.0).

Moreover, there is a relationship between PRACH and PUSCH (Physical Uplink Shared Channel) which is given in Table 6.3.3.2-1. If the SCS for both PRACH and PUSCH is to be 15 KHz, then in principle only one entry in Table 6.3.3.2-1 is to be considered, and in that case, puncturing is not foreseen to be needed.

For the PRACH, it was concluded in in 3GPP meeting RAN1 #111 that no enhancements are required for PRACH to operate NR on transmission bandwidths of <5 MHz for 3 MHz and 5 MHz channel bandwidth, noting that PRACH formats and configurations not fitting into the transmission bandwidth are not applicable. Further, it was agreed that short PRACH formats with 15 kHz SCS, and long PRACH formats with 1.25 kHz SCS are to be supported for transmission bandwidths <5 MHz for 3 MHz and 5 MHz channel bandwidth.

### 6) CSI-RS

The Information Element (IE) CSI-FrequencyOccupation is used to configure the frequency domain occupation of a channel state information measurement resource (e.g. NZP-CSI-RS-Resource, CSI-IM-Resource) (see 3GPP TS 38.331 V17.1.0). The following can be highlighted:
nrofRBs: Number of PRBs across which this CSI (Channel State Information) resource spans. Only multiples of 4 are allowed. The smallest configurable number is the minimum of 24 and the width of the associated BWP (Bandwidth Part). If the configured value is larger than the width of the corresponding BWP, the UE shall assume that the actual CSI-RS bandwidth is equal to the width of the BWP.
startingRB: PRB where this CSI resource starts in relation to common resource block #0 (CRB #0) on the common resource block grid. Only multiples of 4 are allowed (0, 4, . . . ).

For CSI-RS/TRS no puncturing is foreseen to be needed. Depending on the decisions to be taken in RAN4 on how many RBs will compose a bandwidth that “is less than 5 MHz,” the “CSI-FrequencyOccupation” can be updated accordingly to maintain the same degree of flexibility. This topic has not been discussed yet in 3GPP.

### 7) CRB

Common resource blocks (CRB) are numbered from 0 and upwards in the frequency domain for subcarrier spacing configuration u. The center of subcarrier 0 of common resource block 0 for subcarrier spacing configuration u coincides with ‘point A’.

Point A serves as a common reference point for resource block grids and in case of a primary cell (PCell) downlink is obtained from a parameter offsetToPointA representing the frequency offset between point A and the lowest subcarrier of the lowest common resource block, which overlaps with the SS/PBCH block used by the UE for initial cell selection. For operation in FR1 (Frequency Range 1), offsetToPointA is expressed in units of resource blocks assuming 15 kHz subcarrier spacing.

The above 3GPP agreements and conclusions can be found at the Chairman's notes from meeting RAN1 #111 (see 3GPP documents “Chairman Notes RAN1 #111, Agenda Item 9.16.1”, Toulouse, France, Aug. 14-18, 2022 and “Chairman Notes RAN1 #112, Agenda Item 9.16.1”, Athens, Greece, February 27-Mar. 3, 2023.

It is noted that in the present disclosure the terms “RB” and “PRB” are used interchangeably, and both refer to the physical resource blocks (PRBs).

There currently exist certain challenge(s), however. For example, in legacy NR system with 15 kHz SCS, the minimum size of CORESET 0 which can be configured to the UE is 24 PRB. For the use cases considered in the above-mentioned WI, available spectrum/bandwidth for transmission/reception is smaller than 24 PRBs. There is a need to perform PRB puncturing on some signals and channels, e.g., on PDCCH transmitted on CORESET 0.

It is unclear whether and how the UE can know how the CORESET 0 would be punctured. Indication to the UE on which subset of PRBs is used for PDCCH transmission in CORESET 0 (aka. CORESET 0 puncturing) is useful for the UE PDCCH decoding. It is not decided whether and how an indication could be done. There are dependencies between the available transmission bandwidths, punctured SSB bandwidth, and CORESET 0 puncturing which should be taken into account for the CORESET 0 puncturing indication.

### SUMMARY

Certain aspects of the disclosure and their embodiments may provide solutions to these or other challenges. For example, methods and systems are provided for indicating CORESET 0 puncturing to the UE in a simple and efficient manner.

According to certain embodiments, for example, several solutions are provided for indicating CORESET 0 puncturing:
Indication of start and length of the non-punctured part of CORESET 0
Indication of location of the non-punctured part of CORESET 0 in relation to a reference point, e.g., synchronization raster
Indication of the non-punctured part of CORESET 0 based on the carrier bandwidth location associated with the SSB reception.

Certain embodiments may provide one or more of the following technical advantage(s). For example, certain embodiments may provide a technical advantage of providing complete support of NR operation with channel BW of size less than or equal to 5 MHz when there can be different transmission bandwidth restrictions within the channel bandwidth. As another example, certain embodiments may provide a technical advantage of providing simple methods to indicate to the UE how CORESET 0 is punctured which helps the UE in performing PDCCH reception in a more efficient manner with better performance.

According to an embodiment, a method performed by a UE is provided. The method comprises receiving a first physical channel from a network node. Further, the method comprises determining a location of a set of a plurality of PRBs corresponding to a CORESET 0, on which a second physical channel is to be mapped and determining a first subset of PRBs of the set of PRBs of CORESET 0, on which the second physical channel is to be received, wherein the first subset of PRBs is within a maximum transmission bandwidth, and wherein all the PRBs outside the first subset of PRBs are punctured such that the second physical channel is not received on those punctured PRBs. The first subset is determined based on information comprising at least one of:
a location of the first subset of PRBs from the set of PRBs of CORESET 0;
a starting location of the first subset of PRBs;
a length, L, of the first subset of the PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

According to a further embodiment, a method performed by a network node is provided. The method comprises transmitting a first physical channel to a UE. Further, the method comprises transmitting, to the UE, a second physical channel on a set of a plurality of PRBs corresponding to a CORESET 0. The first subset of PRBs is within a maximum transmission bandwidth and all the PRBs outside the first subset of PRBs are punctured such that the second physical channel is not received on those punctured PRBs. A location of the second physical channel on the set of PRBs is based on information comprising at least one of:
a location of the first subset of PRBs from the set of PRBs of CORESET 0;
a starting location of the first subset of PRBs;
a length, L, of the first subset of PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

According to a further embodiment, a UE is provided. The UE is configured to receive a first physical channel from a network node. Further, the UE is configured to determine a location of a set of a plurality of PRBs corresponding to a CORESET 0, on which a second physical channel is to be mapped and determine a first subset of PRBs of the set of PRBs of CORESET 0, on which the second physical channel is to be received, wherein the first subset of PRBs is within a maximum transmission bandwidth, and wherein all the PRBs outside the first subset of PRBs are punctured such that the second physical channel is not received on those punctured PRBs. The first subset is determined based on information comprising at least one of:
a location of the first subset of PRBs from the set of PRBs of CORESET 0;
a starting location of the first subset of PRBs;
a length, L, of the first subset of the PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

According to a further embodiment, a UE is provided. The UE comprises processing circuitry and a memory containing program code executable by the processing circuitry. Execution of the program code by the processing circuitry causes the UE to receive a first physical channel from a network node. Further, execution of the program code causes the UE to determine a location of a set of a plurality of PRBs corresponding to a CORESET 0, on which a second physical channel is to be mapped and determine a first subset of PRBs of the set of PRBs of CORESET 0, on which the second physical channel is to be received, wherein the first subset of PRBs is within a maximum transmission bandwidth, and wherein all the PRBs outside the first subset of PRBs are punctured such that the second physical channel is not received on those punctured PRBs. The first subset is determined based on information comprising at least one of:
a location of the first subset of PRBs from the set of PRBs of CORESET 0;
a starting location of the first subset of PRBs;
a length, L, of the first subset of the PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

According to a further embodiment, a network node is provided. The network node is configured to transmit a first physical channel to a UE. Further, the network node is configured to transmit, to the UE, a second physical channel on a set of a plurality of PRBs corresponding to a CORESET 0. The first subset of PRBs is within a maximum transmission bandwidth and all the PRBs outside the first subset of PRBs are punctured such that the second physical channel is not received on those punctured PRBs. A location of the second physical channel on the set of PRBs is based on information comprising at least one of:
a location of the first subset of PRBs from the set of PRBs of CORESET 0;
a starting location of the first subset of PRBs;
a length, L, of the first subset of PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

According to a further embodiment, a network node is provided. The network node comprises processing circuitry and a memory containing program code executable by the processing circuitry. Execution of the program code by the processing circuitry causes the network node to transmit a first physical channel to a UE. Further, execution of the program code by the processing circuitry causes the network node to transmit, to the UE, a second physical channel on a set of a plurality of PRBs corresponding to a CORESET 0. The first subset of PRBs is within a maximum transmission bandwidth and all the PRBs outside the first subset of PRBs are punctured such that the second physical channel is not received on those punctured PRBs. A location of the second physical channel on the set of PRBs is based on information comprising at least one of:
a location of the first subset of PRBs from the set of PRBs of CORESET 0;
a starting location of the first subset of PRBs;
a length, L, of the first subset of PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

According to a further embodiment, a computer program or computer program product is provided, e.g., in the form of a non-transitory storage medium, which comprises program code to be executed by processing circuitry of a UE. Execution of the program code causes the UE to to receive a first physical channel from a network node. Further, execution of the program code causes the UE to determine a location of a set of a plurality of PRBs corresponding to a CORESET 0, on which a second physical channel is to be mapped and determine a first subset of PRBs of the set of PRBs of CORESET 0, on which the second physical channel is to be received, wherein the first subset of PRBs is within a maximum transmission bandwidth, and wherein all the PRBs outside the first subset of PRBs are punctured such that the second physical channel is not received on those punctured PRBs. The first subset is determined based on information comprising at least one of:
a location of the first subset of PRBs from the set of PRBs of CORESET 0;
a starting location of the first subset of PRBs;
a length, L, of the first subset of the PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

According to a further embodiment, a computer program or computer program product is provided, e.g., in the form of a non-transitory storage medium, which comprises program code to be executed by processing circuitry of a network node. Execution of the program code causes the network node to transmit a first physical channel to a UE. Further, execution of the program code by the processing circuitry causes the network node to transmit, to the UE, a second physical channel on a set of a plurality of PRBs corresponding to a CORESET 0. The first subset of PRBs is within a maximum transmission bandwidth and all the PRBs outside the first subset of PRBs are punctured such that the second physical channel is not received on those punctured PRBs. A location of the second physical channel on the set of PRBs is based on information comprising at least one of:
a location of the first subset of PRBs from the set of PRBs of CORESET 0;
a starting location of the first subset of PRBs;
a length, L, of the first subset of PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

Other features of embodiments of the present disclosure and advantages may be readily apparent to one having skill in the art. Certain embodiments may have none, some, or all of the recited advantages.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates possible scenarios to be supported for operation with less than 5 MHz bandwidth in FR1;

FIG. 2 illustrates a possible configuration of the MIB;

FIG. 3 illustrates a table indicating a maximum number of SSBs per SS burst depending on SCS and carrier frequency;

FIG. 4 illustrates an example of time-frequency structure of the SSB;

FIG. 5 illustrates relationship between the location in the frequency of CORESET 0 and SSB;

FIG. 6 illustrates an example of configuration of the starting PRB and length of the subset of PRBs of the CORESET 0 in which the UE is expected to receive a PDCCH, according to an embodiment of the present disclosure;

FIG. 7 illustrates a further example of configuration of the starting PRB and length of the subset of PRBs of the CORESET 0 in which the UE is expected to receive a PDCCH, according to an embodiment of the present disclosure;

FIG. 8 illustrates an example of a CORESET 0 configuration table according to an embodiment of the present disclosure;

FIG. 9 illustrates a further example of a CORESET 0 configuration table according to an embodiment of the present disclosure;

FIG. 10 illustrates a further example of configuration of the starting PRB and length of the subset of PRBs of the CORESET 0 in which the UE is expected to receive a PDCCH, according to an embodiment of the present disclosure;

FIG. 11 illustrates a further example of configuration of the starting PRB and length of the subset of PRBs of the CORESET 0 in which the UE is expected to receive a PDCCH, according to an embodiment of the present disclosure;

FIG. 12 shows an example of a configuration of a set of resource blocks and slot symbols of CORESET;

FIG. 13 shows a table for illustrating possible puncturing patterns on CORESET 0;

FIG. 14 shows an example of a configuration of a set of resource blocks and slot symbols of CORESET, according to an embodiment of the present disclosure;

FIG. 15 shows an example of a configuration of a set of resource blocks and slot symbols of CORESET, according to an embodiment of the present disclosure;

FIG. 16 shows a table for illustrating an example of resources within an SS/PBCH block;

FIG. 17 illustrates an example of a configuration with 15-PRB maximum transmission bandwidth, 20-PRB SSB structure, and resulting 15-PRB SSB structure and 15-PRB CORESET 0 structure after puncturing, according to an embodiment of the present disclosure;

FIG. 18 illustrates an example of a configuration with 15-PRB maximum transmission bandwidth, 20-PRB SSB structure, and resulting 12-PRB SSB structure and 15-PRB CORESET 0 structure after puncturing, according to an embodiment of the present disclosure;

FIG. 19 illustrates an example of a configuration with 15-PRB maximum transmission bandwidth, 20-PRB SSB structure, and resulting 12-PRB SSB structure and 15-PRB CORESET 0 structure after puncturing, according to an embodiment of the present disclosure;

FIG. 20 illustrates an example of a configuration with 20-PRB maximum transmission bandwidth, 20-PRB SSB structure, and resulting 15-PRB SSB structure and 15-PRB CORESET 0 structure after puncturing, according to an embodiment of the present disclosure;

FIGS. 21A and 21B illustrate examples of permitted configurations of the CORESET 0, according to an embodiment of the present disclosure;

FIG. 22 illustrates an example of a communication system, according to an embodiment of the present disclosure;

FIG. 23 illustrates an example of a UE, according to an embodiment of the present disclosure;

FIG. 24 illustrates an example of a network node, according to an embodiment of the present disclosure;

FIG. 25 illustrates an example of a host, according to an embodiment of the present disclosure;

FIG. 26 illustrates an example of a virtualization environment, according to an embodiment of the present disclosure;

FIG. 27 illustrates an example of a communication diagram of a host communicating via a network node with a UE over a partially wireless connection, according to an embodiment of the present disclosure;

FIG. 28 shows a flowchart for illustrating an example of a UE-based method according to an embodiment of the present disclosure;

FIG. 29 shows a flowchart for illustrating an example of a network-node based method according to an embodiment of the present disclosure.

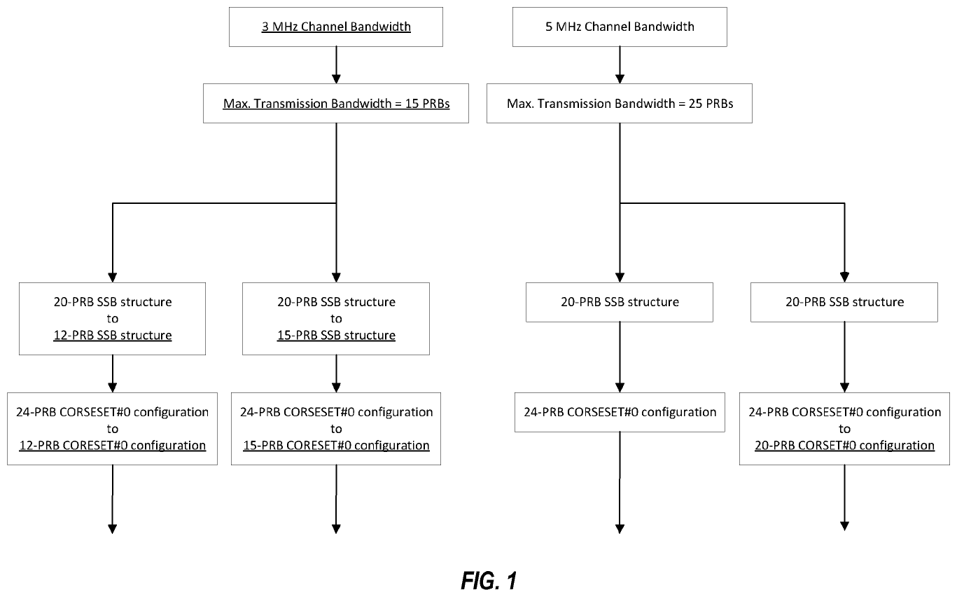

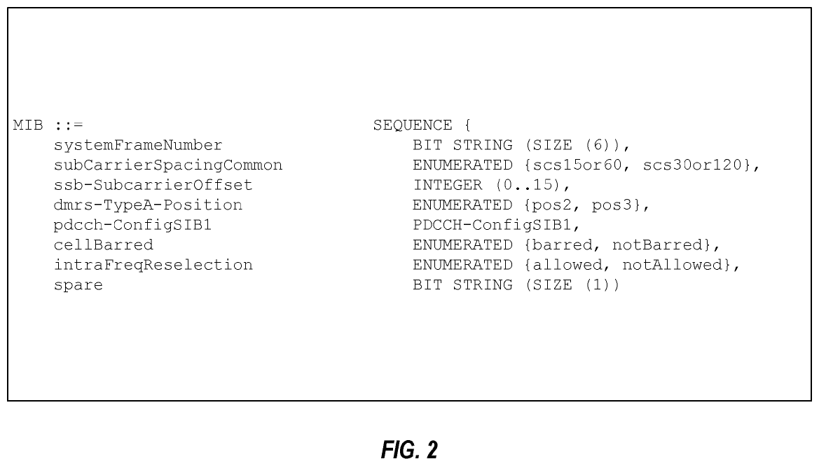

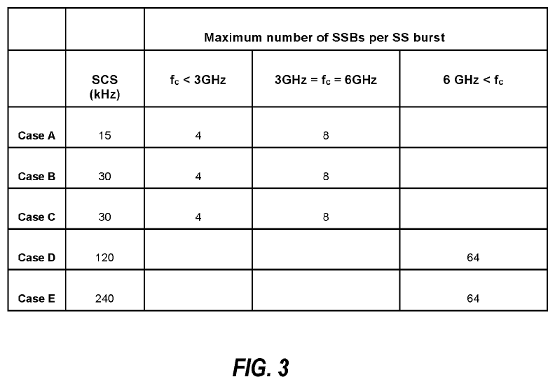

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access (UTRA), Evolved Universal Terrestrial Radio Access (E-UTRA), narrow band internet of things (NB-IoT), WiFi, Bluetooth, next generation RAT, NR, 4G (4th Generation), 5G (5th Generation), etc. Any of the equipment denoted by the terms node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DM-RS signals in SS/PBCH block (SSB), discovery reference signal (DRS), CRS, PRS (Positioning Reference Signal) etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signals (RS) such as SRS (Sounding Reference Signal), DM-RS (Demodulation Reference Signal) etc. The term physical channel refers to any channel carrying higher layer information e.g. data, control etc. Examples of physical channels are PBCH, NPBCH, PDCCH, PDSCH (Physical Downlink Shared Channel), sPUCCH, SPDSCH, sPUCCH, sPUSCH, MPDCCH, NPDCCH (Narrowband PDCCH), NPDSCH, E-PDCCH, PUSCH, PUCCH, NPUSCH, etc.

The term time resource used herein may correspond to any type of physical resource or radio resource expressed in terms of length of time. Examples of time resources are: symbol, time slot, subframe, radio frame, TTI (Transmission Time Interval), interleaving time, slot, sub-slot, mini-slot, system frame number (SFN) cycle, hyper-SFN (H-SFN) cycle etc.

Herein, the term “indication of CORESET 0 puncturing” refers to indication for the subset of PRBs of the CORESET 0 on which the UE is expected to receive PDCCH. Alternatively, it can refer to indication of the subset of PRBs of the CORESET 0 on which the UE is not expected to receive PDCCH. The UE, after receiving the indication of CORESET 0 puncturing, determines a subset of PRBs of CORESET #0 to receive a PDCCH with Type0-PDCCH search space set and then performs the PDCCH reception based on the determined PRBs. The term CORESET 0 refers to CORESET for Type0-PDCCH search space set.

Although some examples are given for a particular frequency band with a certain transmission bandwidth, the embodiments are in general applicable to any frequency bands with any transmission bandwidth.

Indication of “Start and/or Length” of the Non-Punctured Part of CORESET 0

According to certain embodiments, solutions are provided for indicating CORESET 0 puncturing by indicating the non-punctured part of CORESET 0. In particular, the solution focuses on the indication of the starting PRB and the length (in PRBs) of the non-punctured part of CORESET 0.

In a particular embodiment, for example, a UE operating in a channel BW of size less than or equal to 5 MHz is provided with an indication for a starting PRB and a length (in consecutive number of PRBs) of the subset of PRBs of the CORESET 0 in which the UE is expected to receive a PDCCH.

In another particular embodiment, for example, the indication of starting PRB and length of the subset of PRBs of the CORESET 0 in which the UE is expected to receive a PDCCH is applicable to CORESET 0 of size 24 PRBs.

In general, an indication of the starting PRB can be relative to a certain reference PRB. In the following, two example embodiments are described.

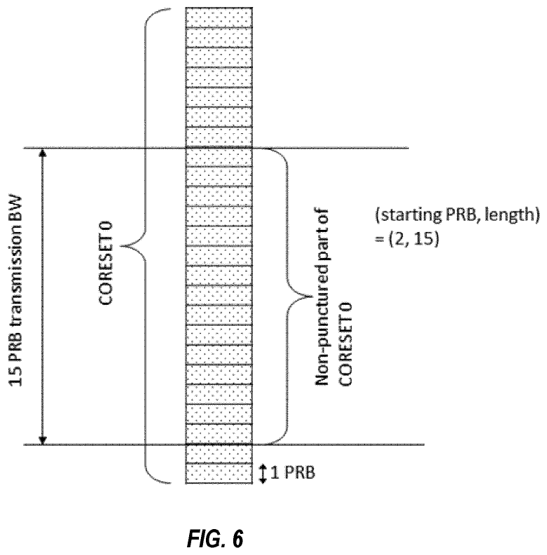

In one embodiment, the starting PRB of the subset of PRBs of the CORESET 0 in which the UE is expected to receive a PDCCH corresponds to the relative starting PRB with respect to the first PRB of CORESET 0. See FIG. 6 for an illustrative example.

FIG. 6 shows an example of the indication of the starting PRB and length of the subset of PRBs of the CORESET 0 in which the UE is expected to receive a PDCCH (aka. non-punctured part of CORESET 0) where the starting PRB index is with respect to the first PRB of CORESET 0. Here the starting PRB index=2, implying that the starting PRB of the non-punctured part of CORESET 0 is PRB #2 of the CORESET 0. Note that PRB index of CORESET 0 is assumed to start from PRB #0.

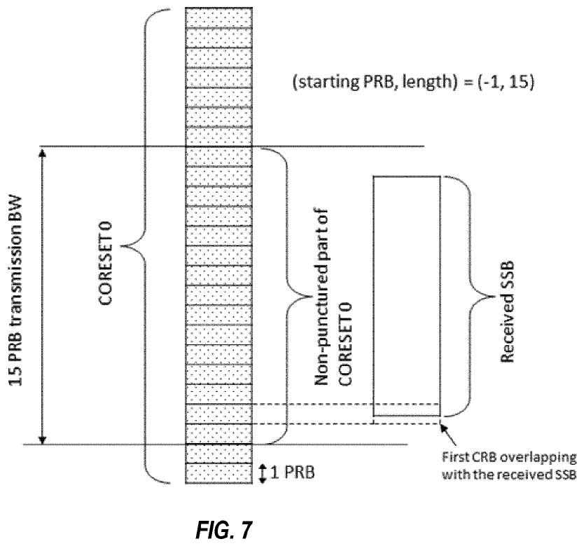

In another embodiment, the starting PRB of the subset of PRBs of the CORESET 0 in which the UE is expected to receive a PDCCH is relative to the first common resource block (CRB) overlapping with the received SSB. The indication of the starting PRB is done via an offset value which can be positive or negative. The UE determines the starting PRB for the subset of PRBs of the CORESET 0 in which the UE is expected to receive a PDCCH based on both the first CRB overlapping with the received SSB and the offset value. See FIG. 7 for an illustrative example.

FIG. 7 shows an example of the indication of the starting PRB and length of the non-punctured part of CORESET 0 where the starting PRB index is with respect to the first CRB overlapping with the received SSB. Here the starting PRB index=−1 implying that the starting PRB of the non-punctured part of CORESET 0 is offset by 1 PRB below the first CRB overlapping with the received SSB.

Indication of the starting PRB and length of the subset of PRBs of the CORESET 0 in which the UE is expected to receive a PDCCH can be done based on some configured values. In the following, we describe some solutions for how the starting PRB and length can be configured to the UE and how they can be indicated.
In one embodiment, one or more values of starting PRB and length of the subset of PRBs of the CORESET 0 in which the UE is expected to receive a PDCCH are configured as part of the CORESET 0 configuration table containing a number of consecutive resource blocks and a number of consecutive symbols for the CORESET 0. See Table 2 for an illustrative example.

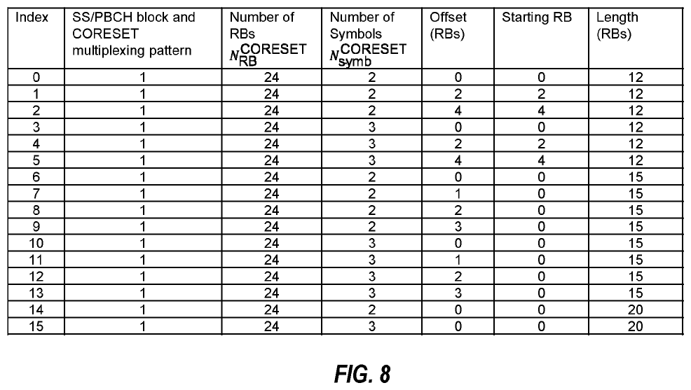

FIG. 8 shows an example of a CORESET 0 configuration table containing a number of consecutive resource blocks and a number of consecutive symbols for the CORESET 0 and the indication for CORESET 0 puncturing in terms of the starting PRB and length of the non-punctured part of CORESET 0. It is noted that that in this example two separate columns for starting PRB and length of the non-punctured part of CORESET 0 are shown. Alternatively, one column with the starting PRB and length combination can be considered.

In such case, the indication of a starting PRB and a length of the subset of PRBs of the CORESET 0 in which the UE is expected to receive a PDCCH is provided by a parameter controlResourceSetZero in pdcch-ConfigSIB1 information element in MIB, indicating an index of the CORESET 0 configuration table. For example, when the UE is configured with CORESET 0 configuration as in Table 2 and the parameter controlResourceSetZero is set to 6, it indicates that the starting PRB and length of the non-punctured part of CORESET 0 are 0 and 15, respectively.

Yet another alternative is to explicitly describe in a column the PRB indices of the non-punctured part of CORESET 0 with respect to the PRB index of CORESET 0. See Table 3 for an illustrating example.

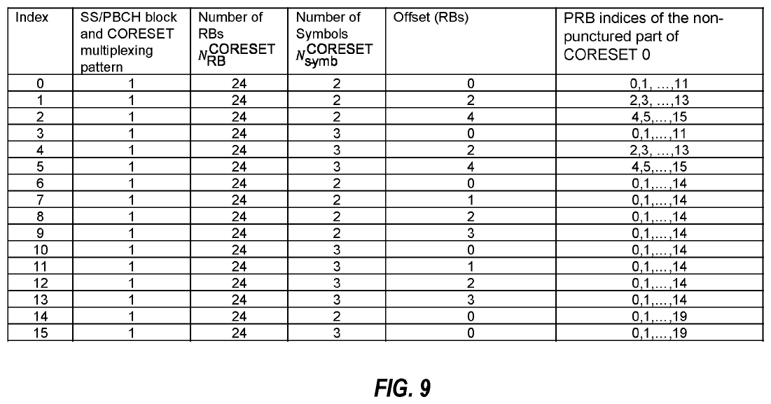

FIG. 9 shows a further example of a CORESET 0 configuration table containing a number of consecutive resource blocks and a number of consecutive symbols for the CORESET 0 and the indication for CORESET 0 puncturing in terms of the PRB indices of the non-punctured part of CORESET 0 with respect to the PRB index of CORESET 0.

Although in general the UE can be provided with indication for both starting PRB and length of the subset of PRBs of the CORESET 0 in which the UE is expected to receive a PDCCH, in some cases, it is sufficient to indicate only one of the starting PRB and length.
In one embodiment, the starting PRB index for the subset of PRBs of the CORESET 0 in which the UE is expected to receive a PDCCH is fixed in the specification. In one example, the starting PRB of the subset of PRBs of the CORESET 0 in which the UE is expected to receive a PDCCH corresponds to the first PRB of CORESET 0.
In another embodiment, the length for the subset of PRBs of the CORESET 0 in which the UE is expected to receive a PDCCH is fixed in the specification.

Although in general it is possible to configure and/or indicate any value of the starting PRB and length of the subset of PRBs of the CORESET 0 in which the UE is expected to receive a PDCCH, in some cases, only some values are preferred.

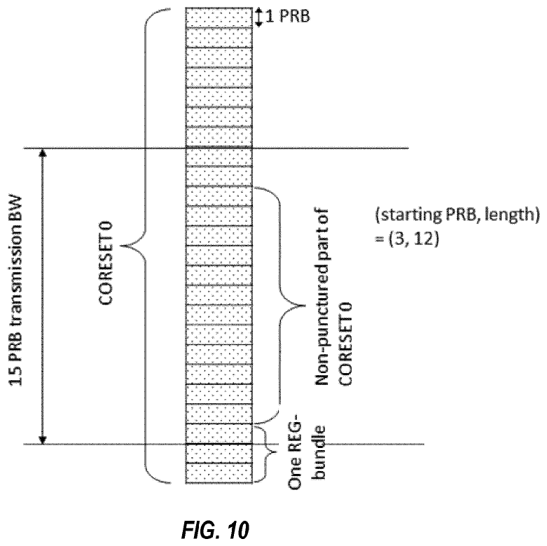

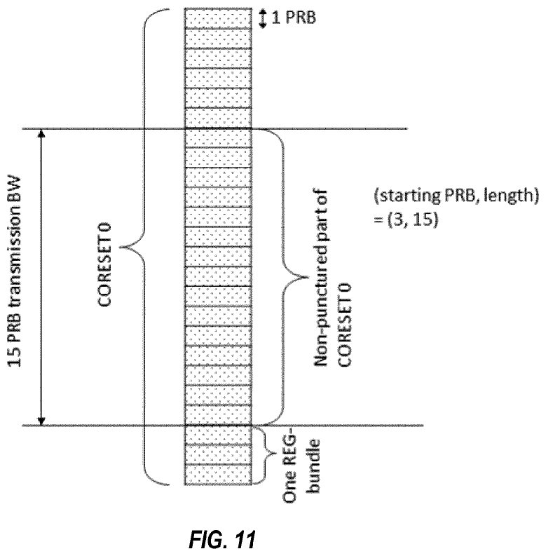

In one embodiment, the indication of a starting PRB index for the subset of PRBs of the CORESET 0 in which the UE is expected to receive a PDCCH is such that the resulting CORESET 0 puncturing is done on a REG-bundle granularity. See FIG. 10 and FIG. 11 for illustrative examples.

FIG. 10 shows an example of indication of the starting PRB and length of the non-punctured part of CORESET 0 where the starting PRB index is with respect to the first PRB of CORESET 0. Here, a REG-bundle size is assumed to span 3 PRBs starting from the first PRB of CORESET 0. The CORESET 0 puncturing is done on a REG-bundle granularity as the starting PRB index=3 implying that the starting PRB of the non-punctured part of CORESET 0 is PRB #3 of the CORESET 0, and the length=12 implying that the non-punctured part of CORESET 0 spans 12 consecutive PRBs.

FIG. 11 show a further example of indication of the starting PRB and length of the non-punctured part of CORESET 0 where the starting PRB index is with respect to the first PRB of CORESET 0. Here, a REG-bundle size is assumed to span 3 PRBs starting from the first PRB of CORESET 0. The CORESET 0 puncturing is done on a REG-bundle granularity as the starting PRB index=3 implying that the starting PRB of the non-punctured part of CORESET 0 is PRB #3 of the CORESET 0, and the length=15 implying that the non-punctured part of CORESET 0 spans 15 consecutive PRBs.

In another embodiment, the length for the subset of PRBs of the CORESET 0 in which the UE is expected to receive a PDCCH is multiple of 3 PRBs or 6 PRBs.

In another embodiment, the minimum value of length for the subset of PRBs of the CORESET 0 in which the UE is expected to receive a PDCCH is 12 PRBs.

Other variants for the indication of the non-punctured part of CORESET 0 can be considered. For example,
Instead of indicating the start and length of the non-punctured part of CORESET 0, the UE is indicated the number of consecutive punctured PRBs applied from the lower and/or upper edge of the CORESET 0. It can be done with the explicit PRB indices of the punctured PRBs similarly as in the table of FIG. 9.
Instead of indicating the start and length of the non-punctured part of CORESET 0, the UE is indicated a subset of non-punctured PRBs of the CORESET 0 by a bitmap where each bit of the bitmap represents a group of M consecutive PRBs, where M is a positive integer. In this case, the indicated non-punctured part of the CORESET 0 is not necessarily contiguous.

### Possible Puncturing Patterns and Indication of the Punctured Part of CORESET 0

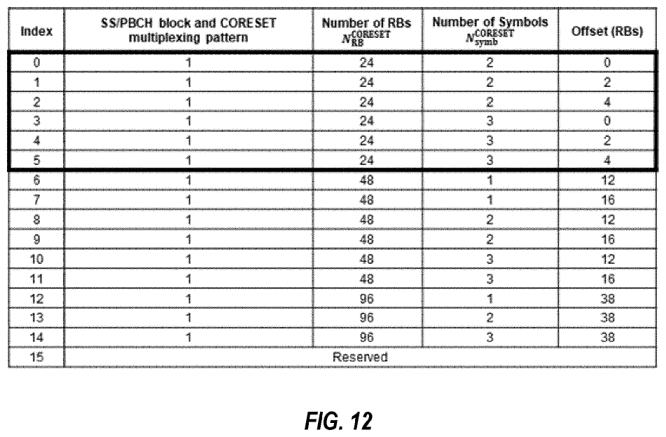

In legacy systems, the smallest size in frequency domain for CORESET 0 configuration consists of 24-PRBs. Moreover, according to the table of FIG. 12, which corresponds to Table 13-1 in 3GPP TS 38.213 V17.3.0, for such a CORESET 0 configuration

$$( i . e . , “ {N}_{RB}^{CORESET} = 24 PRBs ” )$$

Offset (RBs) can only take values 0, 2, and 4 PRBs. The table of FIG. 12shows a set of resource blocks and slot symbols of CORESET for Type0-PDCCH search space set when {SS/PBCH block, PDCCH} SCS is {15, 15} kHz for frequency bands with minimum channel bandwidth 5 MHz or 10 MHz.

In addition, if we consider that the value of K_{ssb} can be in a range from 0 to 11 subcarriers and accounting for the available choices for Offset (RBs), then in principle there are 12+12+12=36 possible displacements that can be applied on a CORESET0's structure.

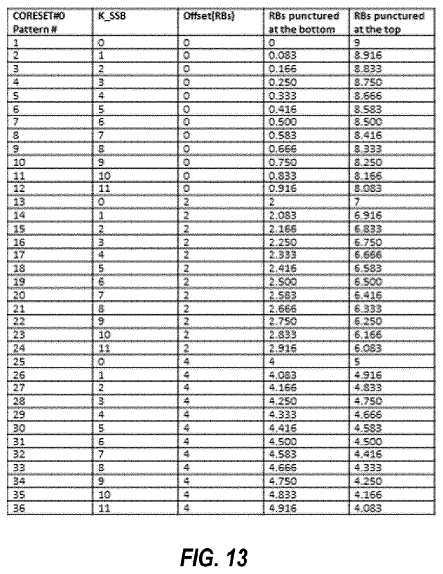

If we assume a scenario where transmission/reception spans up to 15-PRBs, and the legacy 24-PRB CORESET 0 is punctured as to produce a 15-PRB CORESET 0 structure, then all possible puncturing patterns that can be applied on CORSET 0 are summarized in the table of FIG. 13, which illustrates possible puncturing patterns on CORESET 0 accounting for K_{SSB} ranging from 0 to 11, and Offset (RBs) taking values of 0, 2, and 4.It is noted that in the last two columns of the table of FIG. 13, a subcarrier shifting is expressed as a fraction of a PRB (e.g., 3 subcarriers=0.25 PRB). Further, it is noted that the example illustrated below assumes a 15-PRB SSB structure (using such a structure as a reference, and hence both SSB and CORESET 0 structures are aligned at bottom when “K_SSB=0” and “Offset (RBs)=0”). As mentioned earlier, a 24-PRB CORESET 0 configuration was subjected to puncturing.

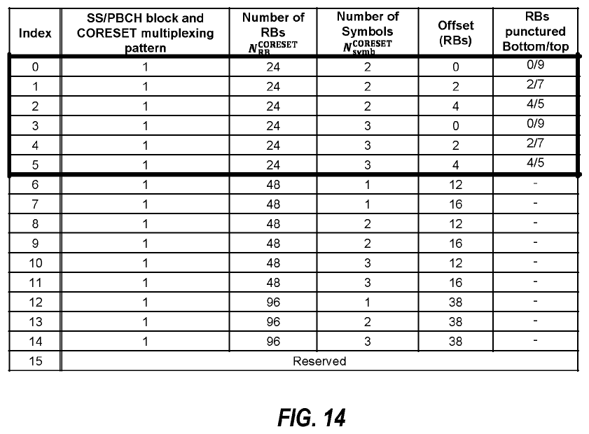

If only PRB-level puncturing were to be adopted for CORESET 0, then the UE would only have to apply 3 out of the 36 possible puncturing patterns as to puncture CORESET 0 depending on the information about “Offset (RBs)” received in MIB. In that case, the legacy table of FIG. 12 could be expanded as shown in the table of FIG. 14 to include the deterministic puncturing patterns that apply on CORESET 0 as a function of “Offset (RBs)”. As can be seen, the table of FIG. 14 indicates a set of of resource blocks and slot symbols of CORESET for Type0-PDCCH search space set when {SS/PBCH block, PDCCH} SCS is {15, 15} kHz for frequency bands with minimum channel bandwidth 3 MHz or 5 MHz, and a set of RBs punctured at the bottom and top.

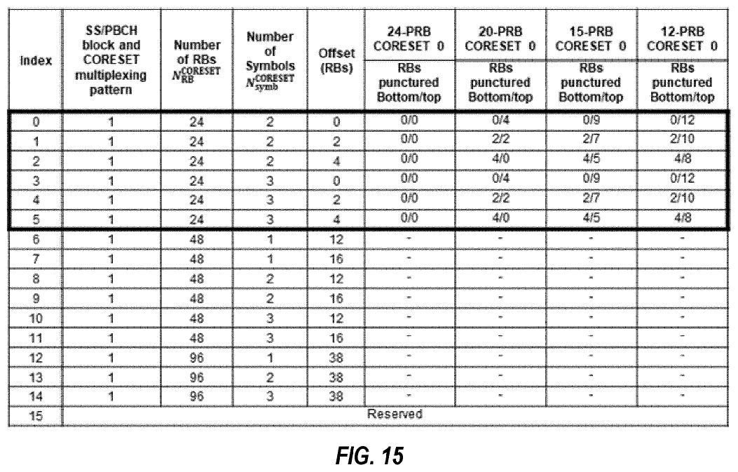

A similar set of all possible puncturing patterns can be generated when CORESET 0 is intended to be fit into a number available PRBs composing the frequency domain other than 15-PRBs. For example, when CORESET 0 is intended keep unpunctured 12-PRBs-of-24-PRBs or 20-PRBs-of-24-PRBs. Then, as to reduce the complexity in terms of searching among all possible puncturing patterns, only a subset of all possible puncturing patterns can be adopted (e.g., only the ones corresponding to a PRB-level puncturing). Below we provide an example, where the table of FIG. 15 shows Table 13-1 further extended as to include other puncturing cases for CORESET 0 as to fit into 20-PRBs, 15-PRBs, and 12-PRBs The distinction between the use-cases (24-PRBs, 20-PRBs, 15-PRBs and 12-PRBs) can be done through a field in the MIB. The table of FIG. 15 illustrates a set of resource blocks and slot symbols of CORESET for Type0-PDCCH search space set when {SS/PBCH block, PDCCH} SCS is {15, 15} kHz for frequency bands with minimum channel bandwidth 3 MHz or 5 MHz.

Indication of CORESET 0 Puncturing Based on a Sync Raster Location on which the UE Receives SSB

This solution takes advantage of the design guidelines which require PSS and SSS to be centered with respect to a given sync raster candidate to be used by the UE. Thus, in this solution both SSB and CORESET 0 are positioned (centered or quasi-centered) with respect to a given sync-raster candidate, in such a way that the sync-raster is used as reference for the UE to count from above and below the number of PRBs to be kept unpunctured for both SSB and CORESET 0 (and conversely the PRBs to be punctured on both SSB and CORESET 0).

The intention of this solution is knowing in advance what deterministic puncturing pattern to apply on SSB and CORESET 0 without having to depend puncturing-wise on any offset (e.g., Offset (RBs)). For example, if certain sync-raster candidates were designed to be used for a 15-PRB SSB structure and some others for a 12-PRB SSB structure, then it will be known in advance which puncturing pattern applies for SSB and CORESET 0. On the other hand, a field in MIB can indicate to the UE whether a 15-PRB or a 12-PRB SSB structure will apply, then the puncturing pattern that applies on SSB will be confirmed and the puncturing patterns that applies for CORESET 0 will be known.

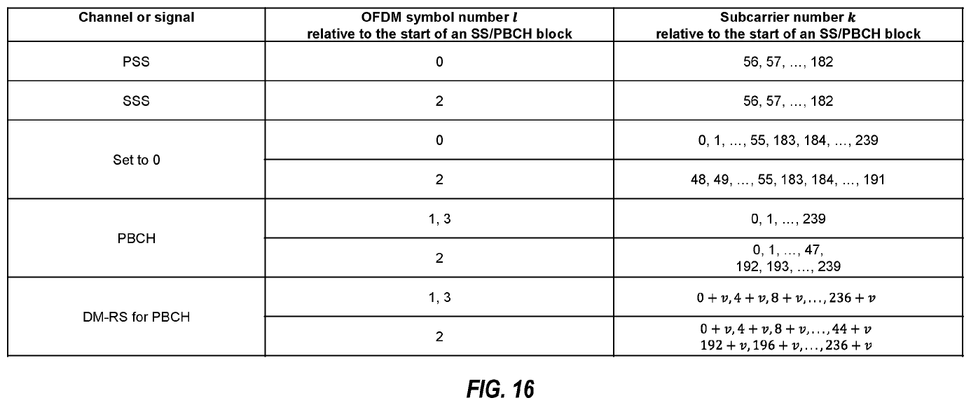

The puncturing applied on SSB relies on a table as illustrated in FIG. 16, which corresponds to Table 7.4.3.1-1 in 3GPP TS 38.211 V17.3.0, which describes the 20-PRB SSB legacy structure, in particular. resources within an SS/PBCH block for PSS, SSS, PBCH, and DM-RS for PBCH.

As complementary information, 3GPP TS 38.104 V17.8.0 (2022-12) mentions that subcarrier=120 is the one on which the sync-raster candidate will be mapped, by specifying a mapping between the synchronization raster and the corresponding resource element (RE), identified by index k=120, of the SS (Synchronization Signal) block. Here, k is the subcarrier number of SS/PBCH block defined in 3GPP TS 38.211 V17.3.0, clause 7.4.3.1.

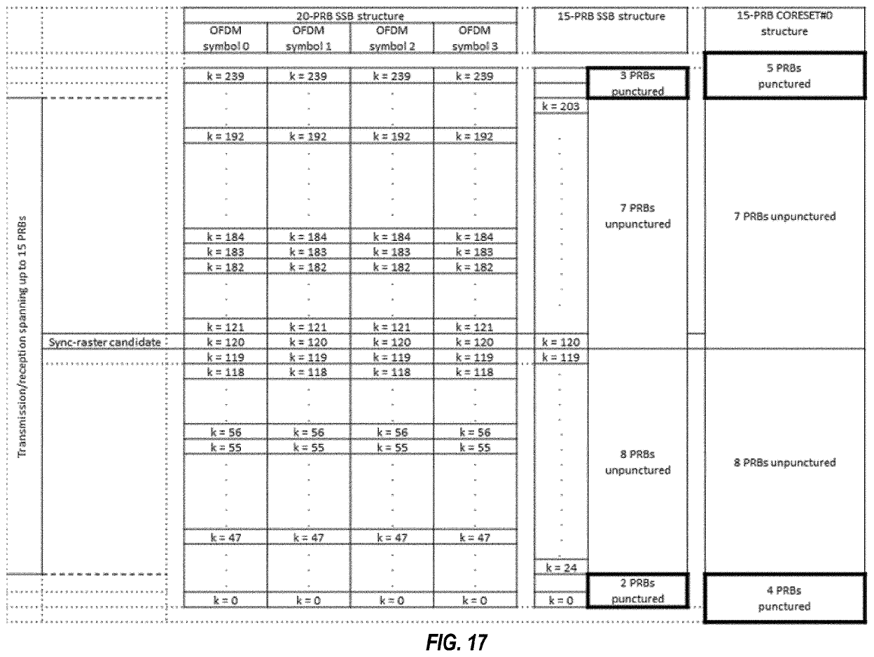

For the case of a, 15-PRB maximum transmission bandwidth (3 MHz CBW), where transmission/reception spans up to 15-PRBs, FIG. 17 illustrates from left-to-right, the 20-PRB SSB structure, and the resulting 15-PRB SSB structure and 15-PRB CORESET 0 structure after puncturing. It is noted that the depicted “15-PRB SSB structure” and the “15-PRB CORESET #0 structure” only illustrate the frequency domain utilization, meaning that the time-domain utilization remains as 4 OFDM symbols for the “15-PRB SSB structure”, and 2-to-3 OFDM symbols for the “15-PRB CORESET #0 structure”.

For the SS/PBCH block, when the UE is operating in channel BW less than 5 MHz the UE is only expected to receive subcarrier number k=24, 23, . . . 203 as described in Table 7.4.3.1-1 of 3GPP TS 38.211 V17.3.0. This means that from the 20-PRB SSB legacy structure, 2-PRBs at the bottom and 3-PRBs at the top would be punctured as to produce a 15-PRBs SSB structure. It is also possible to express the above in terms of the subcarrier number that the UE is not expected to receive (e.g., k=0, 1, . . . 23 and k=204, 205, . . . 239). Note that other SSB puncturing patterns are not excluded.

For CORESET 0, when the UE is operating in channel BW less than 5 MHz,

$${N}_{RB}^{CORESET} = 24 PRBs$$

and the UE is only expected to receive PRB=4, 5, . . . 18. This means that from the 24-PRB CORESET 0 structure, 4-PRBs at the bottom and 5-PRBs at the top would be punctured as to produce a 15-PRBs CORESET 0 structure. It is also possible to express the above in terms of the PRB numbers that the UE is not expected to receive.

The intention of this solution is to be agnostic to the use of offsets towards performing a puncturing on CORESET 0. However, if it were paramount to make use of e.g., “Offset (RBs)” then it can be used to create other puncturing patterns on CORESET 0. For example, the unique deterministic pattern on CORESET 0 as depicted in FIG. 8 can change from puncturing 5-PRBs at the upper-end and 4-PRBs at the lower-end to:
If Offset (RB)=0: Remains the same (i.e., the 24-PRB CORESET #0 structure punctures 5-PRBs at the upper-end and 4-PRBs at the lower-end).
If Offset (RB)=2: The 24-PRB CORESET 0 structure punctures 3-PRBs at the upper-end and 6-PRBs at the lower-end.
If Offset (RB)=4: The 24-PRB CORESET 0 structure punctures 1-PRBs at the upper-end and 8-PRBs at the lower-end.

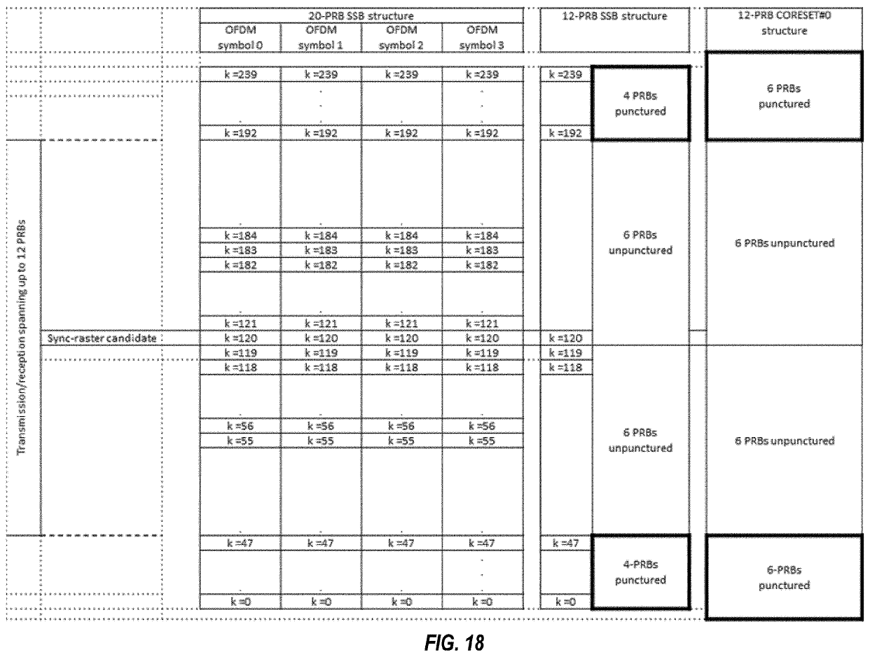

For the case of a 15-PRB maximum transmission bandwidth (3 MHz CBW), where transmission/reception spans up to 12-PRBs, FIG. 18 illustrates from left-to-right, the 20-PRB SSB structure, and the resulting 12-PRB SSB structure and 12-PRB CORESET 0 structure after puncturing. It is noted that the depicted “12-PRB SSB structure” and the “12-PRB CORESET #0 structure” only illustrate the frequency domain utilization, meaning that the time-domain utilization remains as 4 OFDM symbols for the “12-PRB SSB structure”, and 2-to-3 OFDM symbols for the “12-PRB CORESET #0 structure”.

For the SS/PBCH block, when the UE is operating in channel BW less than 5 MHz the UE is only expected to receive subcarrier number k=48, 49, . . . 191 as described in Table 7.4.3.1-1. This means that from the 20-PRB SSB legacy structure, 4-PRBs at the bottom and 4-PRBs at the top would be punctured as to produce a 12-PRBs SSB structure. It is also possible to express the above in terms of the subcarrier number that the UE is not expected to receive (e.g., k=0, 1, . . . 47 and k=192, 193, . . . 239).

For CORESET 0, when the UE is operating in channel BW less than 5 MHz,

$${N}_{RB}^{CORESET} = 24 PRBs$$

and the UE is only expected to receive PRB=6, 7, . . . 17. This means that from the 24-PRB CORESET #0 structure, 6-PRBs at the bottom and 6-PRBs at the top would be punctured as to produce a 12-PRBs CORESET 0 structure. It is also possible to express the above in terms of the PRB numbers that the UE is not expected to receive.

The intention of this proposal is to be agnostic to the use of offsets towards performing a puncturing on CORESET 0. However, if it were paramount to make use of e.g., “Offset (RBs)” then it can be used to create other puncturing patterns on CORESET 0. For example, the unique deterministic pattern on CORESET 0 as depicted in FIG. 18 can change from puncturing 6-PRBs at the upper-end and 6-PRBs at the lower-end to:
If Offset (RB)=0: Remains the same (i.e., the 24-PRB CORESET #0 structure punctures 6-PRBs at the upper-end and 6-PRBs at the lower-end).
If Offset (RB)=2: The 24-PRB CORESET 0 structure punctures 4-PRBs at the upper-end and 8-PRBs at the lower-end.
If Offset (RB)=4: The 24-PRB CORESET 0 structure punctures 2-PRBs at the upper-end and 10-PRBs at the lower-end.

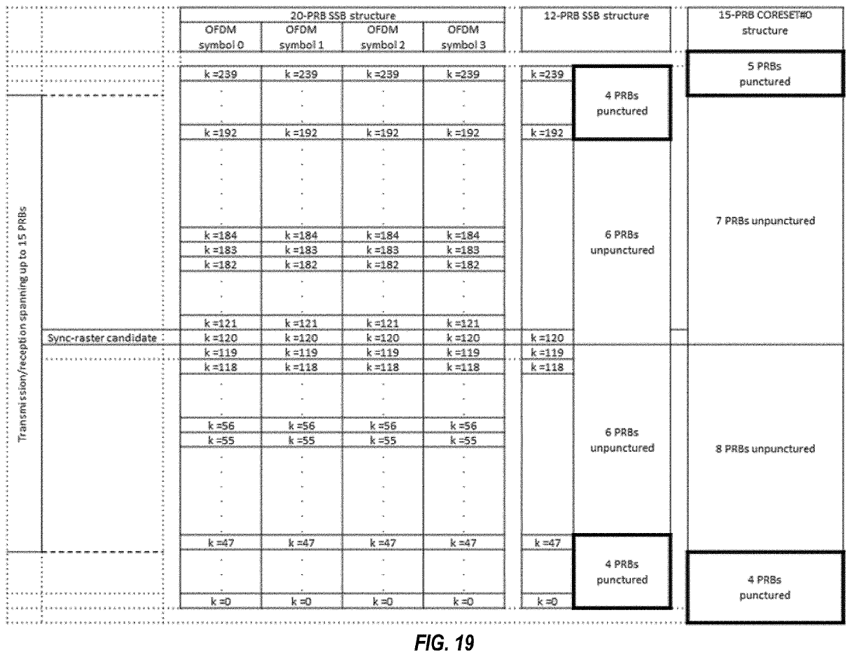

For the case of a 15-PRB maximum transmission bandwidth (3 MHz CBW), where transmission/reception spans up to 15-PRBs or 12-PRBs (mixed scenario), FIG. 19 illustrates from left-to-right, the 20-PRB SSB structure, and the resulting 12-PRB SSB structure and 15-PRB CORESET 0 structure after puncturing. It is noted that the depicted “12-PRB SSB structure” and the “15-PRB CORESET #0 structure” only illustrate the frequency domain utilization, meaning that the time-domain utilization remains as 4 OFDM symbols for the “12-PRB SSB structure”, and 2-to-3 OFDM symbols for the “15-PRB CORESET #0 structure”.

For the SS/PBCH block, when the UE is operating in channel BW less than 5 MHz the UE is only expected to receive subcarrier number k=48, 49, . . . 191 as described in Table 7.4.3.1-1 of 3GPP TS 38.211 V17.3.0. This means that from the 20-PRB SSB legacy structure, 4-PRBs at the bottom and 4-PRBs at the top would be punctured as to produce a 12-PRBs SSB structure. It is also possible to express the above in terms of the subcarrier number that the UE is not expected to receive (e.g., k=0, 1, . . . 47 andk=192, 193, . . . 239).

For CORESET 0, when the UE is operating in channel BW less than 5 MHz,

$${N}_{RB}^{CORESET} = 24 PRBs$$

and the UE is only expected to receive PRB=4, 5, . . . 18. This means that from the 24-PRB CORESET 0 structure, 4-PRBs at the bottom and 5-PRBs at the top would be punctured as to produce a 15-PRBs CORESET #0 structure. It is also possible to express the above in terms of the PRB numbers that the UE is not expected to receive.

The intention of this proposal is to be agnostic to the use of offsets towards performing a puncturing on CORESET 0. However, if it were paramount to make use of e.g., “Offset (RBs)” then it can be used to create other puncturing patterns on CORESET 0. For example, the unique deterministic pattern on CORESET 0 as depicted in FIG. 19 can change from puncturing 5-PRBs at the upper-end and 4-PRBs at the lower-end to:
If Offset (RB)=0: Remains the same (i.e., the 24-PRB CORESET #0 structure punctures 5-PRBs at the upper-end and 4-PRBs at the lower-end).
If Offset (RB)=2: The 24-PRB CORESET 0 structure punctures 3-PRBs at the upper-end and 6-PRBs at the lower-end.
If Offset (RB)=4: The 24-PRB CORESET 0 structure punctures 1-PRBs at the upper-end and 8-PRBs at the lower-end.

For the mixed scenario described in this section, where a 12-PRB SSB structure will co-exist with a 15-PRB CORESET 0, it may happen that some (i.e., among all) of the available sync-raster candidates won't be able to accommodate such a mixture of structures. Hence any of the following strategies can be followed to overcome or at least alleviate any limitation on the usage of the available candidate sync-rasters:
Only a subset from the entire set of sync-raster candidates is used for a mixed scenario where a 12-PRB SSB structure will co-exist with a 15-PRB CORESET 0.
All or most of the sync-raster candidates are used for a mixed scenario where a 12-PRB SSB structure will co-exist with a 15-PRB CORESET 0, through using Offset (RBs) to change the puncturing pattern on CORESET 0 as to increase the changes of utilizing most of the available sync-raster candidates.
All or most of the sync-raster candidates are used for a mixed scenario where a 12-PRB SSB structure will co-exist with a 15-PRB CORESET 0, through using any offset value (including negative and positive integer values) to change the puncturing pattern on CORESET 0 as to increase the changes of utilizing most of the available sync-raster candidates.

Under a 5 MHz umbrella using a maximum transmission bandwidth of 25-PRBs, it will be possible to have transmissions/receptions spanning up to either 25-PRBs (legacy: using a 20-PRB SSB structure and 24-PRB CORESET 0 structure) or 20-PRBs (using a 20-PRB SSB structure and 20-PRB CORESET 0 structure). Under the assumption that the UE will be able to distinguish from information in MIB when transmissions/receptions span up to 25-PRBs or up to 20-PRB, then the puncturing applied on the 24-PRBs CORESET0 to produce a 20-PRBs CORESET 0 may be as explained in the following.

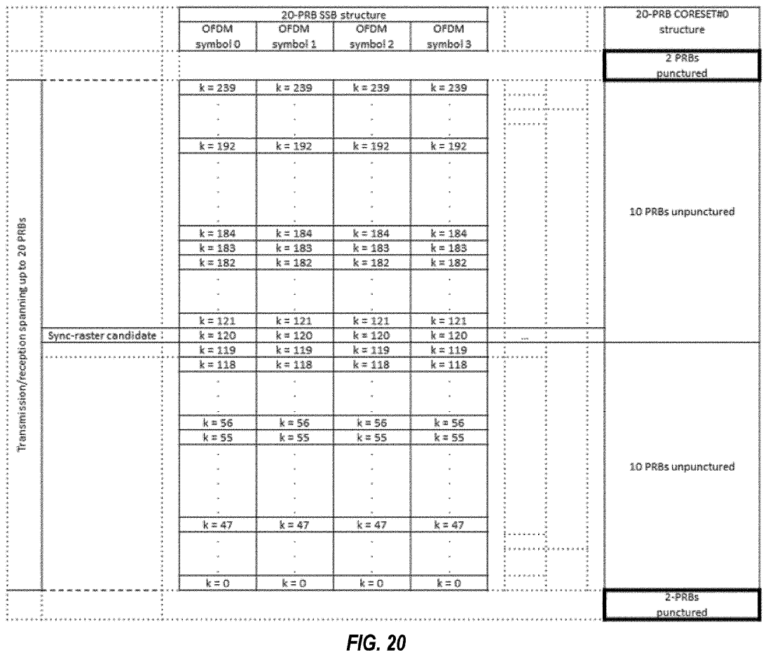

For the case of a 25-PRB maximum transmission bandwidth (5 MHz CBW), where transmission/reception spans up to 25-PRBs or 20-PRBs, FIG. 20 illustrates from left-to-right, the 20-PRB SSB structure, and the resulting 20-PRB CORESET 0 structure after puncturing. It is noted that the depicted “20-PRB CORESET #0 structure” (blue box) only illustrates the frequency domain utilization, meaning that the time-domain utilization remains as 2-to-3 OFDM symbols for the “15-PRB CORESET #0 structure”.

For CORESET 0, when the UE is operating in channel BW less than 5 MHz,

$${N}_{RB}^{CORESET} = 24 PRBs$$

and the UE is only expected to receive PRB=2, 3, . . . 21. This means that from the 24-PRB CORESET 0 structure, 2-PRBs at the bottom and 2-PRBs at the top would be punctured as to produce a 20-PRBs CORESET 0 structure. It is also possible to express the above in terms of the PRB numbers that the UE is not expected to receive.

The intention of this proposal is to be agnostic to the use of offsets towards performing a puncturing on CORESET 0. However, if it were paramount to make use of e.g., “Offset (RBs)” then it can be used to create other puncturing patterns on CORESET 0. For example, the unique deterministic pattern on CORESET 0 as depicted in FIG. 20 can change from puncturing 2-PRBs at the upper-end and 2-PRBs at the lower-end to:
If Offset (RB)=0: Remains the same (i.e., the 24-PRB CORESET 0 structure punctures 2-PRBs at the upper-end and 2-PRBs at the lower-end).
If Offset (RB)=2: The 24-PRB CORESET 0 structure punctures 4-PRBs at the lower-end.
If Offset (RB)=4: The 24-PRB CORESET 0 structure punctures 6-PRBs at the lower-end.
   Indication of CORESET 0 Puncturing Based on Candidates of Channel/Carrier BW Locations Associated with a Synchronization Raster on which the UE Receives SSB

Depending on the synchronization raster design for the 3 MHz channel bandwidth, two or more candidates for the channel/carrier BW locations can be defined to be associated with each synchronization raster entry and standardized into the 3GPP technical specifications.

And in some cases, only one channel/carrier BW candidate location is defined for a subset of synchronization raster entries.

For example, in case of synchronization raster entries for 3 MHz channel BW in band n26, each synchronization raster entry may be associated with up to two channel/carrier bandwidth locations, e.g., for a synchronization raster entry denoted “S4C”, there can be two possible channel/carrier bandwidth locations, one starting from C4S to C4E and another starting from C7S to C7E, while for synchronization raster entry S1C, there is only one associated channel/carrier bandwidth location, starting from C1S to C1E.

In one embodiment, one of the maximum N possible candidates for the channel/carrier BW locations associated with a synchronization raster entry is indicated to the UE, where N is a positive integer larger than 1. In one example, one of the two possible candidates for the channel/carrier BW location associated with a synchronization raster is indicated to the UE.

The UE determines the CORESET 0 puncturing based on the location of CORESET 0 and the indicated channel/carrier BW location. The indication can be part of the CORESET 0 configuration table or as a separate field in MIB or the payload of PBCH.

In the above example, for the synchronization raster entry S4C, the UE could be indicated either [C4S, C4E] or [C7S, C7E] to be the associated channel/carrier bandwidth location. For the synchronization raster entry SIC, the UE is expected to be indicated [C1S, C1E] to be the associated channel/carrier bandwidth location. Alternatively, the UE always determines [C1S, C1E] to be the associated channel/carrier bandwidth location for the synchronization raster entry S1C regardless of the indication.

### Implicit Indication of Transmission Bandwidth and Indication of CORESET 0 Puncturing Based on UE Inference

The UE may use several strategies in locating and/or decoding the non-punctured PRBs of CORESET 0 (or equivalently knowing the locations of the punctured PRBs of CORESET 0) within the carrier bandwidth and also help differentiate between the available transmission bandwidths that are less than or equal to 5 MHz. Here the UE is able to differentiate between different transmission bandwidths and infer the CORESET 0 puncturing because there is a limited set of transmitted SSB lengths and transmitted CORESET 0 pairings to distinguish amongst. Having received the SSB the UE is able to differentiate the transmission bandwidth and infer the CORESET 0 puncturing based on inferring the length of the transmitted SSB, decoding the transmitted SSB and accessing the frequency domain allocation parameters Offset (RB) and the location of the first CRB overlapping with the received SSB known via the K_{ssb} parameter.

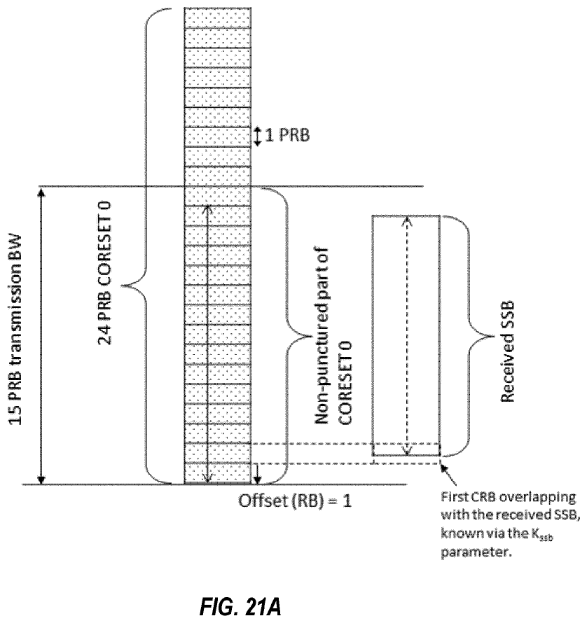

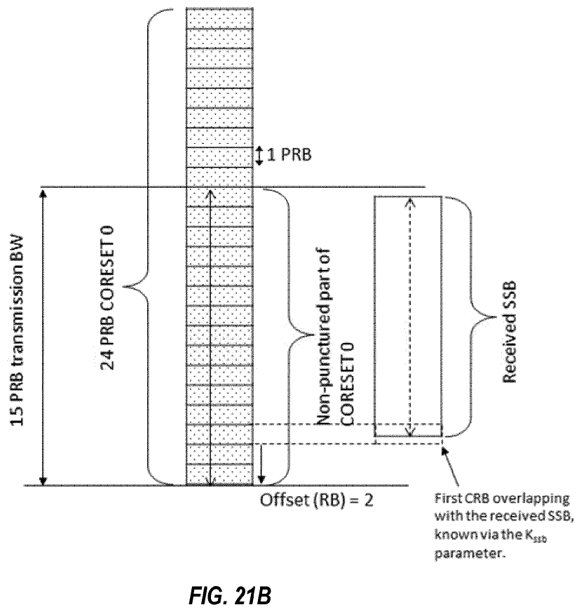

FIG. 21A and FIG. 21B illustrate an example showing permitted configurations of the CORESET 0 such that the first PRB of the 24 PRB CORESET 0 is always within the carrier BW (15 PRB transmission BW). FIG. 21A corresponds to an example where the Offset (RB)=1, and FIG. 21B corresponds to an example where the Offset (RB)=2. This figure also illustrates that the UE may decide to decode at least the first

$$⌈ 12 + Offset ( RB ) + \frac{{K}_{ssb}}{12} ⌉ PRBs$$

(assuming transmitted SSB length is 12 PRBs) of CORESET 0 shown by a double-sided arrow region on CORESET 0.

In one embodiment the BS may transmit an SSB signaling the location of CORESET 0 based on the existing configuration table for 15 kHz SCS, 5 MHz minimum channel BW (i.e., table 13-1 in TS38.213 V17.3.0) or a new configuration table such that the first PRB of the 24 PRBs CORESET 0 is always within the carrier BW.

The Offset (RBs) parameter to specify the frequency domain location of the first PRB of the CORESET 0 may be used to count number of RBs below from the first CRB overlapping with the first transmitted PRB of the SSB (the SSB may be punctured (for BW below 20 PRBs) or not punctured (for BW 20 PRBs and above)). See FIG. 21A and FIG. 21B.

Alternatively, the Offset (RBs) parameter is used to specify the frequency domain location of the first PRB of the CORESET 0 that is used to count the number of RBs above or below (as per a new configuration table similar to table 13-1 in TS38.213 V17.3.0 for appropriate channel BWs) from the first CRB overlapping with the first transmitted PRB of the SSB (the SSB may be punctured (for BW below 20 PRBs) or not punctured (for BW 20 PRBs and above).

According to a further variant, the UE may locate the remaining non-punctured PRBs by counting N PRBs above from the knowledge of the location of the first PRB of the CORESET 0. The value of N may be selected such that N equals the number of transmitted PRB of the SSB (the SSB may be punctured (for BW below 20 PRBs) or not punctured (for BW 20 PRBs and above)). Alternatively, the value of N may be selected such that N is greater than or equal to the

$$⌈ SSB length + Offset ( RB ) + \frac{{K}_{ssb}}{12} ⌉ PRBs .$$

This means that the UE decodes at least the first

$$⌈ SSB length + Offset ( RB ) + \frac{{K}_{ssb}}{12} ⌉ PRBs$$

### of CORESET 0. See FIG. 21A and FIG. 21B.

In a further variant, the UE knows/verifies/confirms the transmission bandwidth of operation via the parameter value of N. That is the value of the parameter N can help differentiate between transmission bandwidths that are less than 5 MHz channel bandwidth.

In a further variant, the value of N is selected dependent on the location of the sync-raster. For instance, for a subset of sync-raster locations the UE selects a value of N=12, or N=15 or N=20. The value of N may be pre-configured by the UE. It can be that the value of N pre-configured by the UE is less than the actual number of non-punctured PRBs transmitted by the BS of CORESET 0. In a further variant, the value of N is chosen as per inference of the previous decoded CORESET 0. In a variant, the UE knows/verifies the location of all the non-punctured PRBs of the CORESET 0 after decoding SIB1 and knowing the parameters of the SIB1, in particular values of the field offsetToCarrier, carrierBandwidth and offsetToPointA. In a variant, the UE may update the value of the parameter N by this inference, verification after decoding SIB1 and knowing the parameters of the SIB1, in particular the values of of the field offsetToCarrier, carrierBandwidth and offsetToPointA.

In one embodiment the BS transmits an SSB signaling the location of CORESET 0 based on the existing configuration table for 15 kHz SCS, 5 MHz minimum channel BW (i.e., table 13-1 in TS38.213 V17.3.0) or a new configuration table such that the UE knows the location of the first transmitted PRB (i.e. the first non-punctured PRB) CORESET 0 relative to the first CRB overlapping with the first transmitted PRB of the SSB (the SSB may be punctured (for BW below 20 PRBs) or not punctured (for BW 20 PRBs and above)) and the location of this first transmitted PRB (i.e. the first non-punctured PRB) relative to the first PRB of the CORESET 0.

In a variant, the Offset (RBs) parameter to specify the frequency domain location of the first transmitted PRB of CORESET 0 may be used to count number of RBs below from the first CRB overlapping with the first transmitted PRB of the SSB (the SSB may be punctured (for BW below 20 PRBs) or not punctured (for BW 20 PRBs and above)).

In a further variant, the Offset (RBs) parameter to specify the frequency domain location of the first transmitted PRB of CORESET 0 may be used to count number of RBs above or below (as per a new configuration table similar to table 13-1 in TS38.213 V17.3.0 for appropriate channel BWs) from the first CRB overlapping with the first transmitted PRB of the SSB (the SSB may be punctured (for BW below 20 PRBs) or not punctured (for BW 20 PRBs and above).

In a further variant, the UE locates the remaining non-punctured PRBs by counting N PRBs above from the knowledge of the location of the first transmitted PRB of CORESET 0.

In a further variant, the value of N is selected such that N equals the number of transmitted PRB of the SSB (the SSB may be punctured (for BW below 20 PRBs) or not punctured (for BW 20 PRBs and above)).

In a further variant, the value of N is selected such that N is greater than or equal to the

$$⌈ SSB length + Offset ( RB ) + \frac{{K}_{ssb}}{12} ⌉ PRBs .$$

This means that the UE decodes at least the first

$$⌈ SSB length + Offset ( RB ) + \frac{{K}_{ssb}}{12} ⌉ PRBs$$

from the knowledge of the location of the first transmitted PRB of CORESET 0.

In a further variant, the UE knows/verifies/confirms the transmission bandwidth of operation via the parameter value of N. That is the value of the parameter N can help differentiate between transmission bandwidths that are less than 5 MHz channel bandwidth.

In a further variant, the value of N is selected dependent on the location of the sync-raster. For instance, for a subset of sync-raster locations the UE selects a value of N=12, or N=15 or N=20.

In a further variant, the value of N is pre-configured by the UE. It can be that the value of N pre-configured by the UE is less than the actual number of non-punctured PRBs transmitted by the BS of CORESET 0.

In a further variant, the value of N is chosen as per inference of the previous decoded CORESET 0.

In a further variant, the UE knows/verifies the location of all the non-punctured PRBs of the CORESET 0 after decoding SIB1 and knowing the values of the parameters of the SIB1, in particular the values of the fields offsetToCarrier, carrierBandwidth and offsetToPointA.

In a further variant, the UE updates the value of the parameter N by this inference, verification after decoding SIB1 and knowing the values of these parameters.

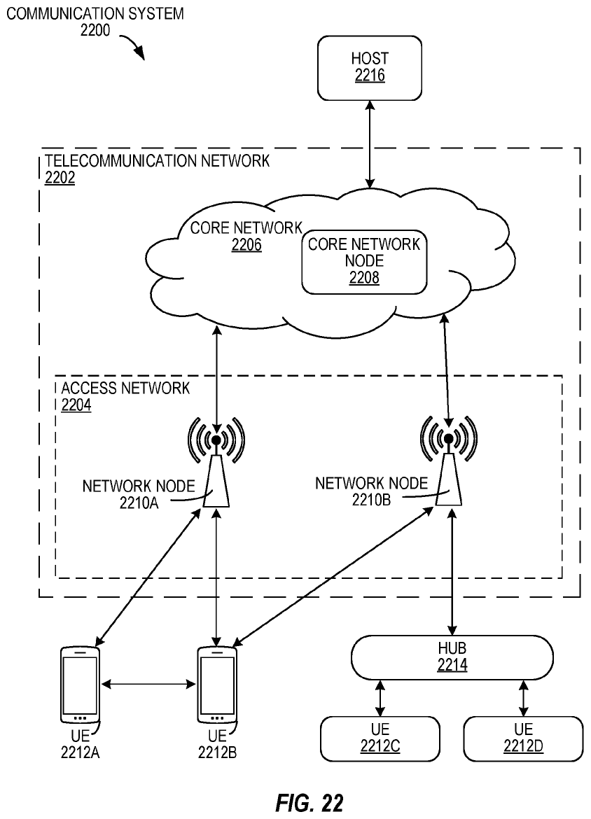

FIG. 22 shows an example of a communication system 2200 in accordance with some embodiments.

In the example, the communication system 2200 includes a telecommunication network 2202 that includes an access network (AN) 2204, such as a radio access network (RAN), and a core network 2206, which includes one or more core network nodes 2208. The access network 2204 includes one or more access network nodes, such as network nodes 2210a and 2210b (one or more of which may be generally referred to as network nodes 2210), or any other similar 3rd Generation Partnership Project (3GPP) access node (AN) or non-3GPP access point (AP). The network nodes 2210 facilitate direct or indirect connection of user equipment (UE), such as by connecting UEs 2212a, 2212b, 2212c, and 2212d (one or more of which may be generally referred to as UEs 2212) to the core network 2206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2200 may include any number of wired or wireless networks, network nodes, UEs, and/or any other components or systems that may facilitate or participate in the communication of data and/or signals whether via wired or wireless connections. The communication system 2200 may include and/or interface with any type of communication, telecommunication, data, cellular, radio network, and/or other similar type of system.

The UEs 2212 may be any of a wide variety of communication devices, including wireless devices arranged, configured, and/or operable to communicate wirelessly with the network nodes 2210 and other communication devices. Similarly, the network nodes 2210 are arranged, capable, configured, and/or operable to communicate directly or indirectly with the UEs 2212 and/or with other network nodes or equipment in the telecommunication network 2202 to enable and/or provide network access, such as wireless network access, and/or to perform other functions, such as administration in the telecommunication network 2202.

In the depicted example, the core network 2206 connects the network nodes 2210 to one or more hosts, such as host 2216. These connections may be direct or indirect via one or more intermediary networks or devices. In other examples, network nodes may be directly coupled to hosts. The core network 2206 includes one more core network nodes (e.g., core network node 2208) that are structured with hardware and software components. Features of these components may be substantially similar to those described with respect to the UEs, network nodes, and/or hosts, such that the descriptions thereof are generally applicable to the corresponding components of the core network node 2208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2216 may be under the ownership or control of a service provider other than an operator or provider of the access network 2204 and/or the telecommunication network 2202, and may be operated by the service provider or on behalf of the service provider. The host 2216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2200 of FIG. 22 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard, e.g., 6G (6th Generation); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2202 is a cellular network that implements 3GPP standardized features. Accordingly, the telecommunications network 2202 may support network slicing to provide different logical networks to different devices that are connected to the telecommunication network 2202. For example, the telecommunications network 2202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT (Internet of Things) services to yet further UEs.

In some examples, the UEs 2212 are configured to transmit and/or receive information without direct human interaction. For instance, a UE may be designed to transmit information to the access network 2204 on a predetermined schedule, when triggered by an internal or external event, or in response to requests from the access network 2204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2214 communicates with the access network 2204 to facilitate indirect communication between one or more UEs (e.g., UE 2212c and/or 2212d) and network nodes (e.g., network node 2210b). In some examples, the hub 2214 may be a controller, router, content source and analytics, or any of the other communication devices described herein regarding UEs. For example, the hub 2214 may be a broadband router enabling access to the core network 2206 for the UEs. As another example, the hub 2214 may be a controller that sends commands or instructions to one or more actuators in the UEs. Commands or instructions may be received from the UEs, network nodes 2210, or by executable code, script, process, or other instructions in the hub 2214. As another example, the hub 2214 may be a data collector that acts as temporary storage for UE data and, in some embodiments, may perform analysis or other processing of the data. As another example, the hub 2214 may be a content source. For example, for a UE that is a VR headset, display, loudspeaker or other media delivery device, the hub 2214 may retrieve VR assets, video, audio, or other media or data related to sensory information via a network node, which the hub 2214 then provides to the UE either directly, after performing local processing, and/or after adding additional local content. In still another example, the hub 2214 acts as a proxy server or orchestrator for the UEs, in particular in if one or more of the UEs are low energy IoT devices.

The hub 2214 may have a constant/persistent or intermittent connection to the network node 2210b. The hub 2214 may also allow for a different communication scheme and/or schedule between the hub 2214 and UEs (e.g., UE 2212c and/or 2212d), and between the hub 2214 and the core network 2206. In other examples, the hub 2214 is connected to the core network 2206 and/or one or more UEs via a wired connection. Moreover, the hub 2214 may be configured to connect to an M2M service provider over the access network 2204 and/or to another UE over a direct connection. In some scenarios, UEs may establish a wireless connection with the network nodes 2210 while still connected via the hub 2214 via a wired or wireless connection. In some embodiments, the hub 2214 may be a dedicated hub—that is, a hub whose primary function is to route communications to/from the UEs from/to the network node 2210b. In other embodiments, the hub 2214 may be a non-dedicated hub—that is, a device which is capable of operating to route communications between the UEs and network node 2210b, but which is additionally capable of operating as a communication start and/or end point for certain data channels.

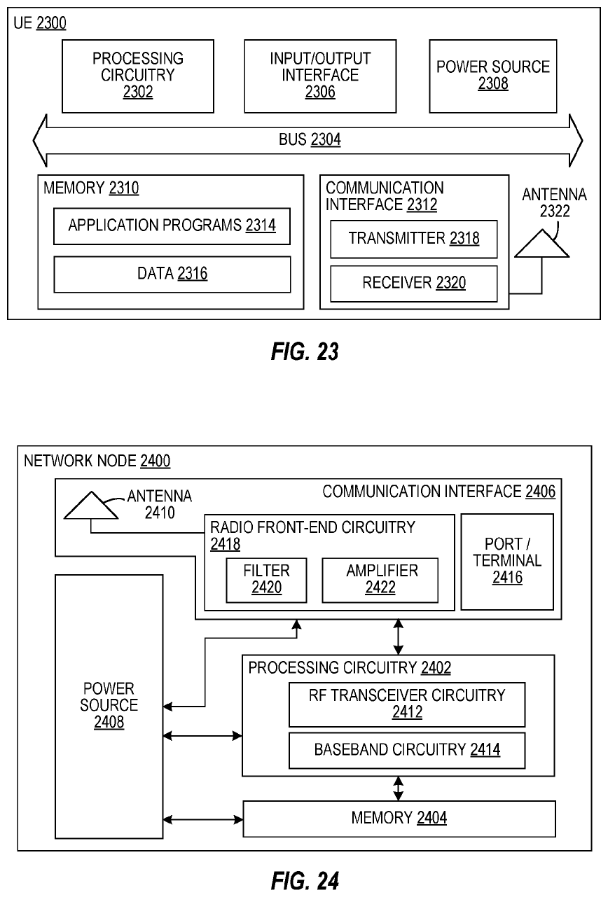

FIG. 23 shows a UE 2300, which may be an embodiment of the UE 112 of FIG. 22, in accordance with some embodiments.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2300 includes processing circuitry 2302 that is operatively coupled via a bus 2304 to an input/output interface 2306, a power source 2308, a memory 2310, a communication interface 2312, and/or any other component, or any combination thereof. Certain UEs may utilize all or a subset of the components shown in FIG. 23. The level of integration between the components may vary from one UE to another UE. Further, certain UEs may contain multiple instances of a component, such as multiple processors, memories, transceivers, transmitters, receivers, etc.

The processing circuitry 2302 is configured to process instructions and data and may be configured to implement any sequential state machine operative to execute instructions stored as machine-readable computer programs in the memory 2310. The processing circuitry 2302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2302 may include multiple central processing units (CPUs).

In the example, the input/output interface 2306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2308 is structured as a battery or battery pack. Other types of power sources, such as an external power source (e.g., an electricity outlet), photovoltaic device, or power cell, may be used. The power source 2308 may further include power circuitry for delivering power from the power source 2308 itself, and/or an external power source, to the various parts of the UE 2300 via input circuitry or an interface such as an electrical power cable. Delivering power may be, for example, for charging of the power source 2308. Power circuitry may perform any formatting, converting, or other modification to the power from the power source 2308 to make the power suitable for the respective components of the UE 2300 to which power is supplied.

The memory 2310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2310 includes one or more application programs 2314, such as an operating system, web browser application, a widget, gadget engine, or other application, and corresponding data 2316. The memory 2310 may store, for use by the UE 2300, any of a variety of various operating systems or combinations of operating systems.

The memory 2310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM (Universal Subscriber Identity Module) and/or ISIM (Integrated Subscriber Identity Module), other memory, or any combination thereof. The UICC may for example be an embedded UICC (eUICC), integrated UICC (iUICC) or a removable UICC commonly known as ‘SIM card.’ The memory 2310 may allow the UE 2300 to access instructions, application programs and the like, stored on transitory or non-transitory memory media, to off-load data, or to upload data. An article of manufacture, such as one utilizing a communication system may be tangibly embodied as or in the memory 2310, which may be or comprise a device-readable storage medium.

The processing circuitry 2302 may be configured to communicate with an access network or other network using the communication interface 2312. The communication interface 2312 may comprise one or more communication subsystems and may include or be communicatively coupled to an antenna 2322. The communication interface 2312 may include one or more transceivers used to communicate, such as by communicating with one or more remote transceivers of another device capable of wireless communication (e.g., another UE or a network node in an access network). Each transceiver may include a transmitter 2318 and/or a receiver 2320 appropriate to provide network communications (e.g., optical, electrical, frequency allocations, and so forth). Moreover, the transmitter 2318 and receiver 2320 may be coupled to one or more antennas (e.g., antenna 2322) and may share circuit components, software or firmware, or alternatively be implemented separately.

In the illustrated embodiment, communication functions of the communication interface 2312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2300 shown in FIG. 23.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 24 shows a network node 2400, which may be an embodiment of the network node 110 of FIG. 22, in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2400 includes a processing circuitry 2402, a memory 2404, a communication interface 2406, and a power source 2408. The network node 2400 may be composed of multiple physically separate components (e.g., a NodeB component and a RNC component, or a BTS component and a BSC component, etc.), which may each have their own respective components. In certain scenarios in which the network node 2400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2400 may be configured to support multiple radio access technologies (RATs). In such embodiments, some components may be duplicated (e.g., separate memory 2404 for different RATs) and some components may be reused (e.g., a same antenna 2410 may be shared by different RATs). The network node 2400 may also include multiple sets of the various illustrated components for different wireless technologies integrated into network node 2400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2400.

The processing circuitry 2402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2400 components, such as the memory 2404, to provide network node 2400 functionality.

In some embodiments, the processing circuitry 2402 includes a system on a chip (SOC). In some embodiments, the processing circuitry 2402 includes one or more of radio frequency (RF) transceiver circuitry 2412 and baseband processing circuitry 2414. In some embodiments, the radio frequency (RF) transceiver circuitry 2412 and the baseband processing circuitry 2414 may be on separate chips (or sets of chips), boards, or units, such as radio units and digital units. In alternative embodiments, part or all of RF transceiver circuitry 2412 and baseband processing circuitry 2414 may be on the same chip or set of chips, boards, or units.

The memory 2404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2402. The memory 2404 may store any suitable instructions, data, or information, including a computer program, software, an application including one or more of logic, rules, code, tables, and/or other instructions capable of being executed by the processing circuitry 2402 and utilized by the network node 2400. The memory 2404 may be used to store any calculations made by the processing circuitry 2402 and/or any data received via the communication interface 2406. In some embodiments, the processing circuitry 2402 and memory 2404 is integrated.

The communication interface 2406 is used in wired or wireless communication of signaling and/or data between a network node, access network, and/or UE. As illustrated, the communication interface 2406 comprises port(s)/terminal(s) 2416 to send and receive data, for example to and from a network over a wired connection. The communication interface 2406 also includes radio front-end circuitry 2418 that may be coupled to, or in certain embodiments a part of, the antenna 2410. Radio front-end circuitry 2418 comprises filters 2420 and amplifiers 2422. The radio front-end circuitry 2418 may be connected to an antenna 2410 and processing circuitry 2402. The radio front-end circuitry may be configured to condition signals communicated between antenna 2410 and processing circuitry 2402. The radio front-end circuitry 2418 may receive digital data that is to be sent out to other network nodes or UEs via a wireless connection. The radio front-end circuitry 2418 may convert the digital data into a radio signal having the appropriate channel and bandwidth parameters using a combination of filters 2420 and/or amplifiers 2422. The radio signal may then be transmitted via the antenna 2410. Similarly, when receiving data, the antenna 2410 may collect radio signals which are then converted into digital data by the radio front-end circuitry 2418. The digital data may be passed to the processing circuitry 2402. In other embodiments, the communication interface may comprise different components and/or different combinations of components.

In certain alternative embodiments, the network node 2400 does not include separate radio front-end circuitry 2418, instead, the processing circuitry 2402 includes radio front-end circuitry and is connected to the antenna 2410. Similarly, in some embodiments, all or some of the RF transceiver circuitry 2412 is part of the communication interface 2406. In still other embodiments, the communication interface 2406 includes one or more ports or terminals 2416, the radio front-end circuitry 2418, and the RF transceiver circuitry 2412, as part of a radio unit (not shown), and the communication interface 2406 communicates with the baseband processing circuitry 2414, which is part of a digital unit (not shown).

The antenna 2410 may include one or more antennas, or antenna arrays, configured to send and/or receive wireless signals. The antenna 2410 may be coupled to the radio front-end circuitry 2418 and may be any type of antenna capable of transmitting and receiving data and/or signals wirelessly. In certain embodiments, the antenna 2410 is separate from the network node 2400 and connectable to the network node 2400 through an interface or port.

The antenna 2410, communication interface 2406, and/or the processing circuitry 2402 may be configured to perform any receiving operations and/or certain obtaining operations described herein as being performed by the network node. Any information, data and/or signals may be received from a UE, another network node and/or any other network equipment. Similarly, the antenna 2410, the communication interface 2406, and/or the processing circuitry 2402 may be configured to perform any transmitting operations described herein as being performed by the network node. Any information, data and/or signals may be transmitted to a UE, another network node and/or any other network equipment.

The power source 2408 provides power to the various components of network node 2400 in a form suitable for the respective components (e.g., at a voltage and current level needed for each respective component). The power source 2408 may further comprise, or be coupled to, power management circuitry to supply the components of the network node 2400 with power for performing the functionality described herein. For example, the network node 2400 may be connectable to an external power source (e.g., the power grid, an electricity outlet) via an input circuitry or interface such as an electrical cable, whereby the external power source supplies power to power circuitry of the power source 2408. As a further example, the power source 2408 may comprise a source of power in the form of a battery or battery pack which is connected to, or integrated in, power circuitry. The battery may provide backup power should the external power source fail.

Embodiments of the network node 2400 may include additional components beyond those shown in FIG. 24 for providing certain aspects of the network node's functionality, including any of the functionality described herein and/or any functionality necessary to support the subject matter described herein. For example, the network node 2400 may include user interface equipment to allow input of information into the network node 2400 and to allow output of information from the network node 2400. This may allow a user to perform diagnostic, maintenance, repair, and other administrative functions for the network node 2400.

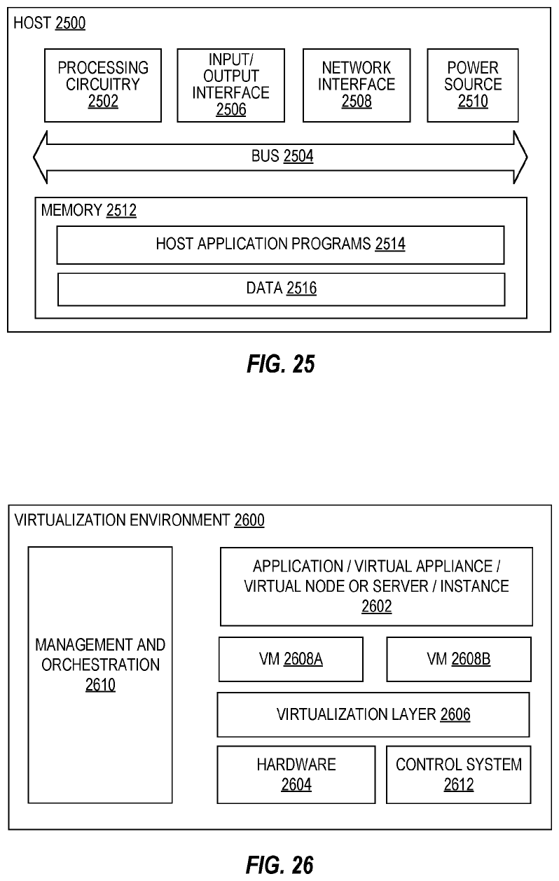

FIG. 25 is a block diagram of a host 2500, which may be an embodiment of the host 2216 of FIG. 22, in accordance with various aspects described herein.

As used herein, the host 2500 may be or comprise various combinations hardware and/or software, including a standalone server, a blade server, a cloud-implemented server, a distributed server, a virtual machine, container, or processing resources in a server farm. The host 2500 may provide one or more services to one or more UEs.

The host 2500 includes processing circuitry 2502 that is operatively coupled via a bus 2504 to an input/output interface 2506, a network interface 2508, a power source 2510, and a memory 2512. Other components may be included in other embodiments. Features of these components may be substantially similar to those described with respect to the devices of previous figures, such as FIGS. 23 and 24, such that the descriptions thereof are generally applicable to the corresponding components of host 2500.

The memory 2512 may include one or more computer programs including one or more host application programs 2514 and data 2516, which may include user data, e.g., data generated by a UE for the host 2500 or data generated by the host 2500 for a UE. Embodiments of the host 2500 may utilize only a subset or all of the components shown. The host application programs 2514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2514 may also provide for user authentication and licensing checks and may periodically report health, routes, and content availability to a central node, such as a device in or on the edge of a core network. Accordingly, the host 2500 may select and/or indicate a different host for over-the-top services for a UE. The host application programs 2514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 26 is a block diagram illustrating a virtualization environment 2600 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2606 (also referred to as hypervisors or virtual machine monitors (VMMs)), provide VMs 2608a and 2608b (one or more of which may be generally referred to as VMs 2608), and/or perform any of the functions, features and/or benefits described in relation with some embodiments described herein. The virtualization layer 2606 may present a virtual operating platform that appears like networking hardware to the VMs 2608.

The VMs 2608 comprise virtual processing, virtual memory, virtual networking or interface and virtual storage, and may be run by a corresponding virtualization layer 2606. Different embodiments of the instance of a virtual appliance 2602 may be implemented on one or more of VMs 2608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2608 may be a software implementation of a physical machine that runs programs as if they were executing on a physical, non-virtualized machine. Each of the VMs 2608, and that part of hardware 2604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2608 on top of the hardware 2604 and corresponds to the application 2602.

Hardware 2604 may be implemented in a standalone network node with generic or specific components. Hardware 2604 may implement some functions via virtualization. Alternatively, hardware 2604 may be part of a larger cluster of hardware (e.g. such as in a data center or CPE) where many hardware nodes work together and are managed via management and orchestration 2610, which, among others, oversees lifecycle management of applications 2602. In some embodiments, hardware 2604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2612 which may alternatively be used for communication between hardware nodes and radio units.

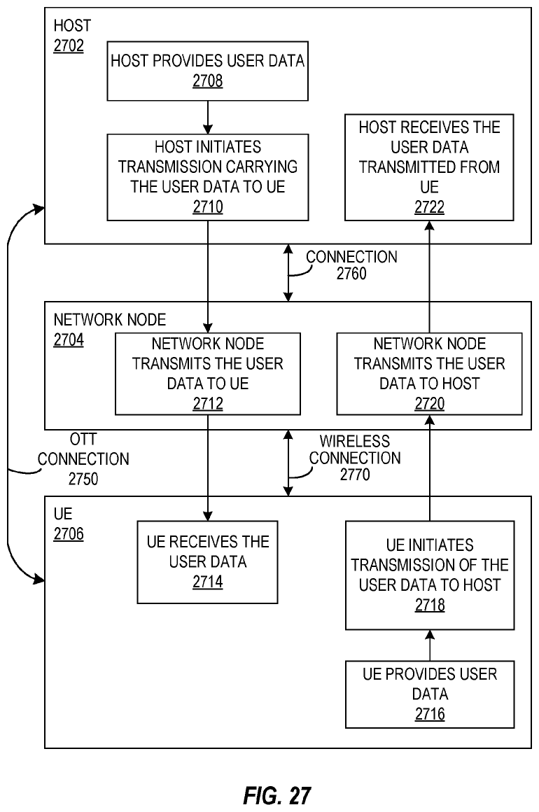

FIG. 27 shows a communication diagram of a host 2702 communicating via a network node 2704 with a UE 2706 over a partially wireless connection in accordance with some embodiments.

Example implementations, in accordance with various embodiments, of the UE (such as a UE 2212a of FIG. 22 and/or UE 2300 of FIG. 23), network node (such as network node 2210a of FIG. 22 and/or network node 2400 of FIG. 24), and host (such as host 2216 of FIG. 22 and/or host 2500 of FIG. 25) discussed in the preceding paragraphs will now be described with reference to FIG. 27.

Like host 2500, embodiments of host 2702 include hardware, such as a communication interface, processing circuitry, and memory. The host 2702 also includes software, which is stored in or accessible by the host 2702 and executable by the processing circuitry. The software includes a host application that may be operable to provide a service to a remote user, such as the UE 2706 connecting via an over-the-top (OTT) connection 2750 extending between the UE 2706 and host 2702. In providing the service to the remote user, a host application may provide user data which is transmitted using the OTT connection 2750.

The network node 2704 includes hardware enabling it to communicate with the host 2702 and UE 2706. The connection 2760 may be direct or pass through a core network (like core network 2206 of FIG. 22) and/or one or more other intermediate networks, such as one or more public, private, or hosted networks. For example, an intermediate network may be a backbone network or the Internet.

The UE 2706 includes hardware and software, which is stored in or accessible by UE 2706 and executable by the UE's processing circuitry. The software includes a client application, such as a web browser or operator-specific “app” that may be operable to provide a service to a human or non-human user via UE 2706 with the support of the host 2702. In the host 2702, an executing host application may communicate with the executing client application via the OTT connection 2750 terminating at the UE 2706 and host 2702. In providing the service to the user, the UE's client application may receive request data from the host's host application and provide user data in response to the request data. The OTT connection 2750 may transfer both the request data and the user data. The UE's client application may interact with the user to generate the user data that it provides to the host application through the OTT connection 2750.

The OTT connection 2750 may extend via a connection 2760 between the host 2702 and the network node 2704 and via a wireless connection 2770 between the network node 2704 and the UE 2706 to provide the connection between the host 2702 and the UE 2706. The connection 2760 and wireless connection 2770, over which the OTT connection 2750 may be provided, have been drawn abstractly to illustrate the communication between the host 2702 and the UE 2706 via the network node 2704, without explicit reference to any intermediary devices and the precise routing of messages via these devices.

As an example of transmitting data via the OTT connection 2750, in step 2708, the host 2702 provides user data, which may be performed by executing a host application. In some embodiments, the user data is associated with a particular human user interacting with the UE 2706. In other embodiments, the user data is associated with a UE 2706 that shares data with the host 2702 without explicit human interaction. In step 2710, the host 2702 initiates a transmission carrying the user data towards the UE 2706. The host 2702 may initiate the transmission responsive to a request transmitted by the UE 2706. The request may be caused by human interaction with the UE 2706 or by operation of the client application executing on the UE 2706. The transmission may pass via the network node 2704, in accordance with the teachings of the embodiments described throughout this disclosure. Accordingly, in step 2712, the network node 2704 transmits to the UE 2706 the user data that was carried in the transmission that the host 2702 initiated, in accordance with the teachings of the embodiments described throughout this disclosure. In step 2714, the UE 2706 receives the user data carried in the transmission, which may be performed by a client application executed on the UE 2706 associated with the host application executed by the host 2702.

In some examples, the UE 2706 executes a client application which provides user data to the host 2702. The user data may be provided in reaction or response to the data received from the host 2702. Accordingly, in step 2716, the UE 2706 may provide user data, which may be performed by executing the client application. In providing the user data, the client application may further consider user input received from the user via an input/output interface of the UE 2706. Regardless of the specific manner in which the user data was provided, the UE 2706 initiates, in step 2718, transmission of the user data towards the host 2702 via the network node 2704. In step 2720, in accordance with the teachings of the embodiments described throughout this disclosure, the network node 2704 receives user data from the UE 2706 and initiates transmission of the received user data towards the host 2702. In step 2722, the host 2702 receives the user data carried in the transmission initiated by the UE 2706.

One or more of the various embodiments improve the performance of OTT services provided to the UE 2706 using the OTT connection 2750, in which the wireless connection 2770 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 2702. As another example, the host 2702 may process audio and video data which may have been retrieved from a UE for use in creating maps. As another example, the host 2702 may collect and analyze real-time data to assist in controlling vehicle congestion (e.g., controlling traffic lights). As another example, the host 2702 may store surveillance video uploaded by a UE. As another example, the host 2702 may store or control access to media content such as video, audio, VR or AR which it can broadcast, multicast or unicast to UEs. As other examples, the host 2702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2750 between the host 2702 and UE 2706, in response to variations in the measurement results. The measurement procedure and/or the network functionality for reconfiguring the OTT connection may be implemented in software and hardware of the host 2702 and/or UE 2706. In some embodiments, sensors (not shown) may be deployed in or in association with other devices through which the OTT connection 2750 passes; the sensors may participate in the measurement procedure by supplying values of the monitored quantities exemplified above, or supplying values of other physical quantities from which software may compute or estimate the monitored quantities. The reconfiguring of the OTT connection 2750 may include message format, retransmission settings, preferred routing etc.; the reconfiguring need not directly alter the operation of the network node 2704. Such procedures and functionalities may be known and practiced in the art. In certain embodiments, measurements may involve proprietary UE signaling that facilitates measurements of throughput, propagation times, latency and the like, by the host 2702. The measurements may be implemented in that software causes messages to be transmitted, in particular empty or ‘dummy’ messages, using the OTT connection 2750 while monitoring propagation times, errors, etc.

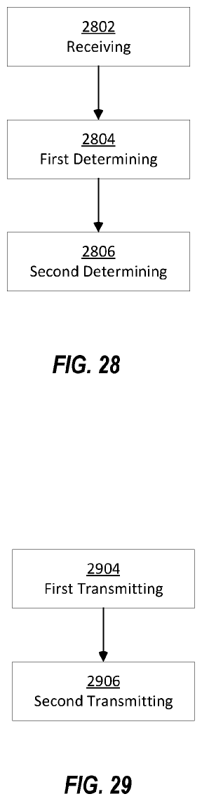

FIG. 28 illustrates an example method by a UE, according to certain embodiments. The UE could for example correspond to the above-mentioned UE 2212A, 2212B, or 2300. At least a part of the steps of the method may be implemented by execution of program code by processing circuitry of the UE. In the illustrated embodiment, the method includes a receiving step at 2802, a first determining step at 2804, and a second determining step 2806. For example, at step 2802, the UE may receive a first physical channel from a network node. The first physical channel may be an SSB. At step 2804, for example, the UE may, based on a location of the first physical channel, and/or a length of the first physical channel, and/or information carried by the first physical channel, determine a location of a set of a plurality of PRBs on which a second physical channel is to be mapped. The set of PRBs may PRBs correspond to a CORESET 0. The second physical channel may be a PDCCH. At step 2806, for example, the UE may determine a first subset of PRBs of the set of PRBs on which the second physical channel is to be received, wherein the first subset of PRBs is within a maximum transmission bandwidth, and wherein all the PRBs outside the first subset of PRBs are punctured such that the second physical channel is not received on those punctured PRBs.

At step 2806, the UE may determine the first subset based on information which includes at least one of:
a location of the first subset of PRBs from the set of PRBs of CORESET 0;
a starting location of the first subset of PRBs;
a length, L, of the first subset of the PRBs;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

At least a part of the information may be fixed by specification.

FIG. 29 illustrates an example method performed by a network node, according to certain embodiments. The network node could for example correspond to the above-mentioned network node 2210A, 2210B, or 2400. At least a part of the steps of the method may be implemented by execution of program code by processing circuitry of the network node. In the illustrated embodiment, the method includes a first transmitting step at 2902 and a second transmitting step at 2904. For example, at step 2902, the network node may transmit a first physical channel to a UE. The first physical channel may be an SSB. At step 2904, for example, the network node may transmit, to the UE, a second physical channel on a set of a plurality of PRBs. The second physical channel may be a PDCCH. A location of the second physical channel on the set of PRBs is based on a location of the first physical channel, and/or a length of the first physical channel, and/or information carried by the first physical channel. The first subset of PRBs is within a maximum transmission bandwidth, and all the PRBs outside the first subset of PRBs are punctured such that the second physical channel is not received on those punctured PRBs.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLES

### Group A Examples

Example A1. A method performed by a user equipment comprising:
any of the user equipment steps, features, or functions described above, either alone or in combination with other steps, features, or functions described above.

Example A2. The method of the previous example, further comprising one or more additional user equipment steps, features or functions described above.

Example A3. The method of any of the previous examples, further comprising:
providing user data; and
forwarding the user data to a host computer via the transmission to the network node.

### Group B Examples

Example B1. A method performed by a network node comprising:
any of the network node steps, features, or functions described above, either alone or in combination with other steps, features, or functions described above.

Example B2. The method of the previous example, further comprising one or more additional network node steps, features or functions described above.

Example B3. The method of any of the previous embodiments, further comprising:
obtaining user data; and
forwarding the user data to a host or a user equipment.

### Group C Examples

Example C1. A method performed by a user equipment (UE) comprising:
receiving a first physical channel from a network node;
based on a location of the first physical channel, and/or a length of the first physical channel, and/or information carried by the first physical channel, determining a location of a set of a plurality of physical resource blocks (PRBs) on which a second physical channel is to be mapped; and
determining a first subset of PRBs of the set of PRBs on which the second physical channel is to be received, wherein the first subset of PRBs is within a maximum transmission bandwidth, and wherein all the PRBs outside the first subset of PRBs are punctured such that the second physical channel is not received on those punctured PRBs.

Example C2. The method of Example C1, wherein the set of PRBs correspond to a Control Resource Set 0 (CORESET 0).

Example C3. The method of Example C2, wherein the information carried by or determined based on the first physical channel comprises at least one of:
a location of the first subset of PRBs from the set of PRBs of CORESET 0;
a starting location of the first subset of PRBs;
a length, L, of the subset of the PRBs of CORESET 0;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

Example C4. The method of any one of Examples C1 to C3, wherein:
the first physical channel is a first physical broadcast channel, and
the second physical channel is physical downlink control channel (PDCCH).

Example C5. The method of Example C4, wherein the first physical broadcast channel comprises a Synchronization Signal/Physical Broadcast Channel Block (SSB).

Example C6. The method of any one of Examples C1 to C5, comprising at least one of:
monitoring for the second physical channel in the location of the first subset of PRBs or in the PRBs that are not comprised by the second subset of PRBs; and
receiving the second physical channel from the network node in the location of the first subset of PRBs or in the PRBs that are not comprised by the second subset of PRBs.

Example C7. The method of any one of Examples C1 to C5, comprising at least one of:
determining that the UE cannot expect to receive the second physical channel on the PRBs outside the first subset of PRBs, or in the PRBs that are comprised by the second subset of PRBs; and
not receiving the second physical channel on the PRBs outside the first subset of PRBs, or in the PRBs that are comprised by the second subset of PRBs.

Example C8. The method of any one of Examples C1 to C7, wherein the first downlink physical channel comprises an indicator that indicates an entry in a configuration table, and wherein determining the location of the set of PRBs on which the second downlink physical channel is to be mapped is based on the entry in the configuration table.

Example C9. The method of Example C8, wherein the configuration table uses one or more of the following elements: SS/PBCH block and CORESET multiplexing pattern, Number of RBs, Number of symbols, Offset (RBs), as in the case of a minimum channel bandwidth of 5 MHz and a subcarrier spacing of 15 KHz.

Example C10. The method of any one of Examples C1 to C9, wherein the first physical channel indicates and/or is associated with an offset parameter, and wherein a location of a first PRB of the first subset of PRBs is determined based on the offset parameter.

Example C11. The method of Example C10, wherein the offset parameter indicates a number of resource blocks (RBs) below a first common resource block that overlaps with a first PRB of the first physical channel.

Example C12. The method of Example C10, wherein the offset parameter indicates a number of resource blocks (RBs) above a first common resource block that overlaps with a first PRB of the first physical channel.

Example C13. The method of any one of Examples C1 to C12, wherein determining the location of the set of PRBs on which the second physical channel is to be mapped comprises:
determining a location of a first PRB of the first subset of PRBs, and
determining a location of at least one additional PRB in the first subset of PRBs based on the location of the first PRB of the first subset of PRBs.

Example C14. The method of Example C13, wherein the first subset of PRBs includes the first PRB and a number of PRBs, N, on either side of the first PRB.

Example C15. The method of Example C13, wherein a value of N is equal to a number of transmitted PRBs of the SSB.

Example C16. The method of Example C13, wherein a value of N is selected to be greater than or equal to the

$$⌈ SSB length + Offset ( RB ) + \frac{{K}_{ssb}}{12} ⌉ PRBs .$$

Example C17. The method of Example C16, comprising determining the maximum transmission bandwidth based on the value of N.

Example C18. The method of Example C13, wherein a value of N is selected based on a location of a synchronization raster.

Example C19. The method of Example C13, wherein a value of N is selected, determined, and/or pre-configured by the UE.

Example C20. The method of Example C19, wherein the value of N is selected, determined, and/or pre-configured based on a previously decoded CORESET 0.

Example C21. The method of Example C13, wherein the location of the at least one additional PRB in the set of PRBs is determined based on at least one of:
a decoding of a SIB1,
a value associated with an offsetToCarrier field,
a value associated with a carrierBandwidth field, and
a value associated with a offsetToPointA field.

Example C22. The method of Example C21, comprising: based on determining the location of the at least one additional PRB in the first subset of PRBs, updating a value, N, associated with a number of PRBs in the first subset of PRBs.

Example C23. The method of any one of Examples C1 to C22, wherein the first physical channel is punctured when the maximum transmission bandwidth or the available transmission bandwidth within the maximum transmission bandwidth is smaller than 20 PRBs.

Example C24. The method of any one of Examples C1 to C23, wherein the set of PRBs from CORESET 0 on which the Physical Downlink Control Channel (PDCCH) is mapped, are punctured when the maximum transmission bandwidth or the available transmission bandwidth within the maximum transmission bandwidth is smaller than 24 PRBs.

Example C25. The method of any one of Examples C1 to C24, wherein the location of the set of PRBs on which the second physical channel is to be mapped is determined based on the location of the first physical channel with respect to a synchronization raster candidate.

Example C26. The method of Example C27, wherein the first physical channel is centered or quasi-centered with respect to the synchronization raster candidate and where the set of PRBs are centered or quasi-centered with respect to the synchronization raster candidate, and where the PRBs from set of PRBs that exceed from above and below the size of first physical channel are punctured.

Example C27. The method of any one of Examples C1 to C26, comprising receiving information indicating a set of lengths with which the first physical channel may be associated, and wherein the location of the set of PRBs on the which the second physical channel is to be mapped is determined based on the length of the first physical channel being a particular one of the set of lengths.

Example C28. The method of Examples of any of Examples C1 to C27, further comprising:
providing user data; and
forwarding the user data to a host via the transmission to the network node.

Example C29. A user equipment comprising processing circuitry configured to perform any of the methods of Examples C1 to C28.

Example C30. A user equipment configured to perform any of the methods of Examples C1 to C28.

Example C31. A wireless device comprising processing circuitry configured to perform any of the methods of Examples C1 to C28.

Example C32. A computer program comprising instructions which when executed on a computer perform any of the methods of Examples C1 to C28.

Example C33. A computer program product comprising computer program, the computer program comprising instructions which when executed on a computer perform any of the methods of Examples C1 to C28.

Example C34. A non-transitory computer readable medium storing instructions which when executed by a computer perform any of the methods of Examples C1 to C28.

### Group D Examples

Example D1. A method performed by a network node comprising:
transmitting a first physical channel to a User Equipment (UE); and
transmitting, to the UE, a second physical channel on a set of a plurality of physical resource blocks (PRBs),
wherein a location of the second physical channel on the set of PRBs is based on a location of the first physical channel, and/or a length of the first physical channel, and/or information carried by the first physical channel,
wherein the first subset of PRBs is within a maximum transmission bandwidth, and
wherein all the PRBs outside the first subset of PRBs are punctured such that the second physical channel is not received on those punctured PRBs.

Example D2. The method of Example D1, wherein the set of PRBs correspond to a Control Resource Set 0 (CORESET 0).

Example D3. The method of Example D2, wherein the information carried by or determined based on the first physical channel comprises at least one of:
a location of the first subset of PRBs from the set of PRBs of CORESET 0;
a starting location of the first subset of PRBs;
a length, L, of the subset of the PRBs of CORESET 0;
a second subset of PRBs to be punctured at the lower end and/or the upper end from the set of PRBs comprising CORESET 0 in the frequency-domain, wherein the second subset of PRBs is the part of a transmission not expected to be received by the UE, wherein the PRBs that are not comprised by the second subset of PRBs is where the second physical channel is expected to be received by the UE.

Example D4. The method of any one of Examples D1 to D3, wherein:
the first physical channel is a first physical broadcast channel, and
the second physical channel is physical downlink control channel (PDCCH).

Example D5. The method of Example D4, wherein the first physical broadcast channel comprises a Synchronization Signal/Physical Broadcast Channel Block (SSB).

Example D6. The method of any one of Examples D1 to D5, comprising at least one of:
configuring the UE to monitor for the second physical channel in the location of the first subset of PRBs or in the PRBs that are not comprised by the second subset of PRBs; and
configuring the UE to receive the second physical channel from the network node in the location of the first subset of PRBs or in the PRBs that are not comprised by the second subset of PRBs.

Example D7. The method of any one of Examples D1 to D5, comprising at least one of:
configuring the UE to determine that the UE cannot expect to receive the second physical channel on the PRBs outside the first subset of PRBs, or in the PRBs that are comprised by the second subset of PRBs; and
configuring the UE to not receive the second physical channel on the PRBs outside the first subset of PRBs, or in the PRBs that are comprised by the second subset of PRBs.

Example D8. The method of any one of Examples D1 to D7, wherein the first downlink physical channel comprises an indicator that indicates an entry in a configuration table, and wherein the location of the set of PRBs on which the second downlink physical channel is to be mapped is determined based on the entry in the configuration table.

Example D9. The method of Example D8, wherein the configuration table uses one or more of the following elements: SS/PBCH block and CORESET multiplexing pattern, Number of RBs, Number of symbols, Offset (RBs), as in the case of a minimum channel bandwidth of 5 MHz and a subcarrier spacing of 15 KHz.

Example D10. The method of any one of Examples D1 to D9, wherein the first physical channel indicates and/or is associated with an offset parameter, and wherein a location of a first PRB of the first subset of PRBs is determined based on the offset parameter.

Example D11. The method of Example D10, wherein the offset parameter indicates a number of resource blocks (RBs) below a first common resource block that overlaps with a first PRB of the first physical channel.

Example D12. The method of Example D10, wherein the offset parameter indicates a number of resource blocks (RBs) above a first common resource block that overlaps with a first PRB of the first physical channel.

Example D13. The method of any one of Examples D1 to D12, comprising configuring the UE to:
determine a location of a first PRB of the first subset of PRBs, and
determine a location of at least one additional PRB in the first subset of PRBs based on the location of the first PRB of the first subset of PRBs.

Example D14. The method of Example D13, wherein the first subset of PRBs includes the first PRB and a number of PRBs, N, on either side of the first PRB.

Example D15. The method of Example D13, wherein a value of N is equal to a number of transmitted PRBs of the SSB.

Example D16. The method of Example D13, wherein a value of N is selected to be greater than or equal to the

$$⌈ SSB length + Offset ( RB ) + \frac{{K}_{ssb}}{12} ⌉ PRBs .$$

Example D17. The method of Example D16, comprising the maximum transmission bandwidth is determined based on the value of N.

Example D18. The method of Example D13, wherein a value of N is selected based on a location of a synchronization raster.

Example D19. The method of Example D13, wherein a value of N is selected, determined, and/or pre-configured by the UE.

Example D20. The method of Example D19, wherein the value of N is selected, determined, and/or pre-configured based on a previously decoded CORESET 0.

Example D21. The method of Example D13, wherein the location of the at least one additional PRB in the set of PRBs is determined based on at least one of:
a decoding of a SIB1,
a value associated with an offsetToCarrier field,
a value associated with a carrierBandwidth field, and
a value associated with a offsetToPointA field.

Example D22. The method of Example D21, comprising configuring the UE to: based on determining the location of the at least one additional PRB in the first subset of PRBs, update a value, N, associated with a number of PRBs in the first subset of PRBs.

Example D23. The method of any one of Examples D1 to D22, wherein the first physical channel is punctured when the maximum transmission bandwidth or the available transmission bandwidth within the maximum transmission bandwidth is smaller than 20 PRBs.

Example D24. The method of any one of Examples D1 to D23, wherein the set of PRBs from CORESET 0 on which the Physical Downlink Control Channel (PDCCH) is mapped, are punctured when the maximum transmission bandwidth or the available transmission bandwidth within the maximum transmission bandwidth is smaller than 24 PRBs.

Example D25. The method of any one of Examples D1 to D24, wherein the location of the set of PRBs on which the second physical channel is to be mapped is determined based on the location of the first physical channel with respect to a synchronization raster candidate.

Example D26. The method of Example D27, wherein the first physical channel is centered or quasi-centered with respect to the synchronization raster candidate and where the set of PRBs are centered or quasi-centered with respect to the synchronization raster candidate, and where the PRBs from set of PRBs that exceed from above and below the size of first physical channel are punctured.

Example D27. The method of any one of Examples D1 to D26, comprising transmitting, to the UE, information indicating a set of lengths with which the first physical channel may be associated, and wherein the location of the set of PRBs on the which the second physical channel is to be mapped is determined based on the length of the first physical channel being a particular one of the set of lengths.

Example D28. The method of any of Examples D1 to D27, further comprising:
obtaining user data; and
forwarding the user data to a host or a user equipment.

Example D29. A network node comprising processing circuitry configured to perform any of the methods of Examples D1 to D28.

Example D30. A network node configured to perform any of the methods of Examples D1 to D28.

Example D31. A computer program comprising instructions which when executed on a computer perform any of the methods of Examples D1 to D28.

Example D32. A computer program product comprising computer program, the computer program comprising instructions which when executed on a computer perform any of the methods of Examples D1 to D28.

Example D33. A non-transitory computer readable medium storing instructions which when executed by a computer perform any of the methods of Examples D1 to D28.

### Group E Examples

Example E1. A user equipment comprising:
processing circuitry configured to perform any of the steps of any of the Group A and C Example Embodiments; and
power supply circuitry configured to supply power to the processing circuitry.

Example E2. A network node comprising:
processing circuitry configured to perform any of the steps of any of the Group B and D Example Embodiments;
power supply circuitry configured to supply power to the processing circuitry.

Example E3. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A and C Example Embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Example E4. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A and C Example Embodiments to receive the user data from the host.

Example E5. The host of the previous Example Embodiment, wherein the cellular network further includes a network node configured to communicate with the UE to transmit the user data to the UE from the host.

Example E6. The host of the previous 2 Example Embodiments, wherein:
the processing circuitry of the host is configured to execute a host application, thereby providing the user data; and
the host application is configured to interact with a client application executing on the UE, the client application being associated with the host application.

Example E7. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

Example E8. The method of the previous Example Embodiment, further comprising:
at the host, executing a host application associated with a client application executing on the UE to receive the user data from the UE.

Example E9. The method of the previous Example Embodiment, further comprising:
at the host, transmitting input data to the client application executing on the UE, the input data being provided by executing the host application,
wherein the user data is provided by the client application in response to the input data from the host application.

Example E10. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A and C Example Embodiments to transmit the user data to the host.

Example E11. The host of the previous Example Embodiment, wherein the cellular network further includes a network node configured to communicate with the UE to transmit the user data from the UE to the host.

Example E12. The host of the previous 2 Example Embodiments, wherein:
the processing circuitry of the host is configured to execute a host application, thereby providing the user data; and
the host application is configured to interact with a client application executing on the UE, the client application being associated with the host application.

Example E13. A method implemented by a host configured to operate in a communication system that further includes a network node and a user equipment (UE), the method comprising:
at the host, receiving user data transmitted to the host via the network node by the UE, wherein the UE performs any of the steps of any of the Group A and C Example Embodiments to transmit the user data to the host.

Example E14. The method of the previous Example Embodiment, further comprising:
at the host, executing a host application associated with a client application executing on the UE to receive the user data from the UE.

Example E15. The method of the previous Example Embodiment, further comprising:
at the host, transmitting input data to the client application executing on the UE, the input data being provided by executing the host application,
wherein the user data is provided by the client application in response to the input data from the host application.

Example E16. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example E17. The host of the previous Example Embodiment, wherein:
the processing circuitry of the host is configured to execute a host application that provides the user data; and
the UE comprises processing circuitry configured to execute a client application associated with the host application to receive the transmission of user data from the host.

Example E18. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B and D Example Embodiments to transmit the user data from the host to the UE.

Example E19. The method of the previous Example Embodiment, further comprising, at the network node, transmitting the user data provided by the host for the UE.

Example E20. The method of any of the previous 2 Example Embodiments, wherein the user data is provided at the host by executing a host application that interacts with a client application executing on the UE, the client application being associated with the host application.

Example E21. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example E22. The communication system of the previous Example Embodiment, further comprising:
the network node; and/or
the user equipment.

Example E23. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example E24. The host of the previous 2 Example Embodiments, wherein:
the processing circuitry of the host is configured to execute a host application, thereby providing the user data; and
the host application is configured to interact with a client application executing on the UE, the client application being associated with the host application.

Example E25. The host of the any of the previous 2 Example Embodiments, wherein the initiating receipt of the user data comprises requesting the user data.

Example E26. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B and D Example Embodiments to receive the user data from the UE for the host.

Example E27. The method of the previous Example Embodiment, further comprising at the network node, transmitting the received user data to the host.

In view of the above, aspects concerning the SSB and CORESET 0 address use cases as further detailed below.

### Use-Cases to be Supported Using the 3 MHz Channel Bandwidth Framework

Under a 3 MHz channel bandwidth framework, in principle two scenarios can be be supported: A) Scenario A where UL/DL transmissions span over 15-PRBs, and B) Scenario B where UL/DL transmissions span over 12-PRBs.

These use-cases illustrated can be implemented under the umbrella of a 3 MHz channel bandwidth using a maximum transmission bandwidth of 15-PRBs, which requires applying puncturing on the 20-PRB SSB legacy structure as to fit such PHY-channel into the reduced bandwidth.

Accordingly, a working assumption in these use cases may be that, for transmission bandwidth(s) of <5 MHz, for PBCH, in the case(s) that available PRBs for PBCH transmission is less than 20PRB, the PBCH based on RB-level puncturing (i.e., PBCH encoding is based on 20PRB. The encoded bits and DM-RS are mapped to 20PRBs based on legacy SSB structure, and those PRBs that fall outside of available PRBs for PBCH transmission are punctured). Typically, there is no need for further optimization. For a 3 MHz channel Bandwidth the legacy 20-PRB SSB structure may need to be punctured as to produce two cases, a 15-PRB SSB structure and a 12-PRB SSB structure.

### Puncturing on SSB and CORESET #0 to Support Transmission Spanning Over 12-PRBs

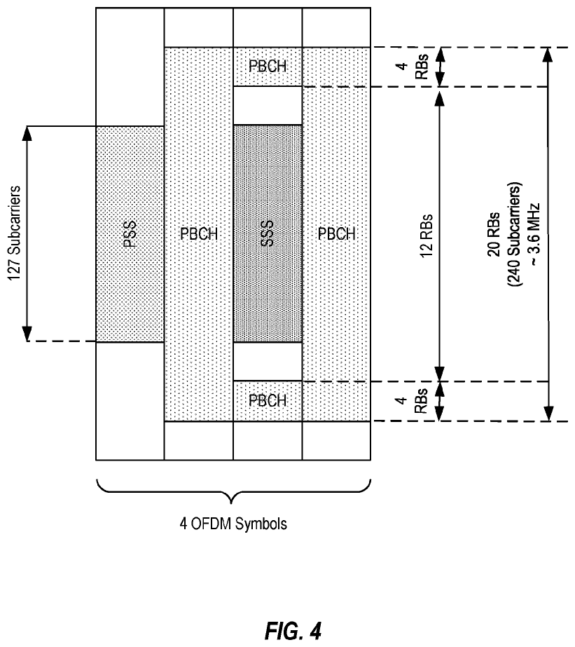

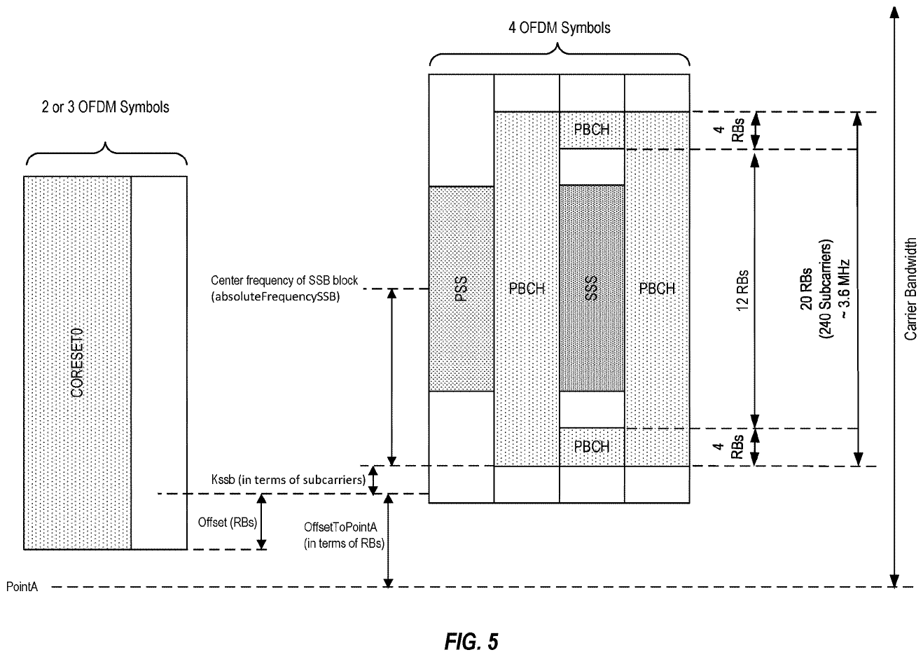

FIG. 4 depicts the legacy 20-PRB SSB.As can be seen. from a 20-PRB SSB legacy structure, the possible ways of applying an “RB-level puncturing” as to obtain a 15-PRB SSB structure and a 12-PRB SSB structure are as follows:
The 15-PRB SSB structure can be obtained from puncturing: a) 4 RBs from top and 1 RB from bottom, b) 1 RB from top and 4 RBs from bottom, c) 3 RBs from top and 2 RBs from bottom, or d) 2 RBs from top and 3 RBs from bottom.
The 12-PRB SSB structure can be obtained from puncturing 4 RBs from top & 4 RB from bottom.

Based on the previous observation and aiming for commonality in the puncturing design, the puncturing alternatives that in common (i.e., for 12-PRB and 15-PRB SSB) include puncturing 4RBs are the ones to be further considered:
The 15-PRB SSB structure can be obtained from puncturing: a) 4 RBs from top and 1 RB from bottom, b) 1 RB from top & 4 RBs from bottom.
The 12-PRB SSB structure can be obtained from puncturing 4 RBs from top and 4 RB from bottom.

For 3 MHz channel BW, the legacy 20-PRB SSB structure punctures “4 RBs from top and 1 RB from bottom” to produce a 15-PRB SSB structure.

For 3 MHz channel BW, the legacy 20-PRB SSB structure punctures “4 RBs from top and 4 RB from bottom” to produce a 12-PRB SSB structure.

In relation with the puncturing applied on SSB, several candidate recovery techniques can be considered. Simulation results show that the performance difference between the legacy 20-PRB SSB structure and the 15-PRB SSB punctured structure is ~1.75 dB, whereas with respect to the 12-PRB SSB punctured structure the performance difference is ~3.6 dB (expressed in terms of the SNR (Signal to Noise Ratio) required to achieve 1% BLER (Block Error Rate) and assuming the same power per sub-carrier for both the non-punctured and punctured PBCH). The performance difference between a punctured and a non-punctured SSB is therefore small (~1.75 dB and ~3.6 dB at 1% BLER when 15-PRBs and 12-PRBs are respectively kept unpunctured). Moreover, SSB is not foreseen to be a bottle-neck channel link budget-wise. In view of such small performance difference was small usage of a compensation technique (e.g., power boosting) may not be needed. For 3 MHz channel bandwidth, it may be considered to refrain from introducing SSB recovery techniques impacting the technical specification.

Another aspect to considered is that “subcarrier 0 of the first resource block of the SS/PBCH block” is used in several parts of the legacy specification as a reference point. For 3 MHz channel BW, the question is whether “subcarrier 0 of the first resource block of the SS/PBCH block” will continue being counted with respect to the legacy 20-PRB SSB structure or with respect to the 15-PRB SSB structure and 12-PRB SSB structure respectively.

In legacy specification “subcarrier 0 of the first resource block of the SS/PBCH block” is used as reference point. For 3 MHz channel BW, the question is whether such a reference point will continue being counted with respect to the legacy 20-PRB SSB structure or with respect to the punctured SSB structures.

PSS/SSS can expected to be centered with respect to each candidate sync-raster, and if the legacy 20-PRB SSB structure as per Table 7.4.3.1-1 in TS 38.211 V17.3.0 is used as a reference to apply the puncturing, then “subcarrier 0 of the first resource block of the SS/PBCH block” can continue being counted with respect to the legacy 20-PRB SSB structure which will minimize the specification impacts, and will bring commonality with the 5 MHz channel BW case which uses a 20-PRB SSB structure for both the regular use-case and its sub-case.

For 3 MHz channel bandwidth, the legacy reference point can remain unmodified and “subcarrier 0 of the first resource block of the SS/PBCH block” can continue being counted with respect to the legacy 20-PRB SSB since such a structure is anyway used as a reference to apply the puncturing.

As with the legacy SSB structure, CORESET #0 needs to be punctured to fit into 15-PRBs and 12-PRBs respectively. The starting point can be relying on the minimum available CORESET #0 configuration equal to 24-PRBs, then the puncturing on CORESET #0 can also be a PRB-level puncturing with “kSSB=0” and with “Offset (RBs)” either fixed as to have only 1 puncturing pattern per time-domain structure (i.e., 2 and 3 OFDM symbols) or variable as per legacy (choosing Offset (RBs) between 0, 2, and 4) as to have 3 puncturing patterns per time-domain structure (i.e., 2 and 3 OFDM symbols).

For 3 MHz channel bandwidth, a PRB-level puncturing is applied on the minimum available legacy CORESET 0's configuration which is equal to 24-PRBs. KSSB=0, such as the n-th Common Resource Block (CRB) in the “Common Resource Block grid” is PRB-level aligned with the reference SSB structure, which in turn sets the location of CORESET 0 using “Offset (RBs)”.

For a 3 MHz channel BW using a 15-PRB CORESET 0 structure, down-select between having a single RB-level puncturing pattern for CORESET 0 or three RB-level puncturing patterns for CORESET 0 derived from using all applicable Offset RBs:
Alternative 1: Single RB-level puncturing pattern for CORESET 0 equally applicable for 2 and 3 OFDM symbols: The legacy 24-PRB CORESET 0 structure punctures “1 RB from bottom and 8 RBs from top” to produce a 15-PRB SSB structure. Only “Offset=0” is used.
Alternative 2: Three RB-level puncturing patterns for CORESET 0 equally applicable for 2 and 3 OFDM symbols: Offset RBs=0: The legacy 24-PRB CORESET 0 structure punctures “1 RB from bottom and 8 RBs from top” to produce a 15-PRB SSB structure. Offset RBs=2: The legacy 24-PRB CORESET 0 structure punctures “3 RBs from bottom and 6 RBs from top” to produce a 15-PRB SSB structure. Offset RBs=4: The legacy 24-PRB CORESET 0 structure punctures “5 RBs from bottom and 4 RBs from top” to produce a 15-PRB SSB structure.

For a 3 MHz channel BW using a 12-PRB CORESET 0 structure, it can be selected between having a single RB-level puncturing pattern for CORESET 0 or three RB-level puncturing patterns for CORESET 0 derived from using all applicable Offset RBs:
Alternative 1: Single RB-level puncturing pattern for CORESET 0 equally applicable for 2 and 3 OFDM symbols: The legacy 24-PRB CORESET 0 structure punctures “4 RBs from bottom and 8 RBs from top” to produce a 12-PRB SSB structure. Only “Offset=0” is used.
Alternative 2: Three RB-level puncturing patterns for CORESET 0 equally applicable for 2 and 3 OFDM symbols: Offset RBs=0: The legacy 24-PRB CORESET 0 structure punctures “4 RBs from bottom and 8 RBs from top” to produce a 12-PRB SSB structure. Offset RBs=2: The legacy 24-PRB CORESET 0 structure punctures “6 RBs from bottom and 6 RBs from top” to produce a 12-PRB SSB structure. Offset RBs=4: The legacy 24-PRB CORESET 0 structure punctures “8 RBs from bottom and 4 RBs from top” to produce a 12-PRB SSB structure.

Based on simulations, several candidate recovery techniques have been considered to be applied on the punctured CORESET 0 structure. It was found that the performance difference between the unpunctured legacy 24-PRB CORESET #0 structure and the punctured 15-PRB CORESET 0 structure, resulted in ~2.7 dB for 2-OFDM symbol and ~2.1 dB for 3-OFDM symbol CORESET #0, respectively (assuming the same power per sub-carrier for both non-punctured and punctured CORESET 0.) For a 12-PRB CORESET 0 structure the performance is expected to be additionally impacted, nonetheless CORESET 0 is not expected to be a bottle-neck channel link budget-wise. Thus, for 3 MHz channel bandwidth, it may be refrained from introducing/supporting CORESET #0 recovery techniques impacting the technical specification.

### Use-Case to be Supported Using the 5 MHz Channel Bandwidth Framework

As mentioned above, for the 5 MHz channel bandwidth: the PBCH transmission bandwidth may be 20 PRBs, and the legacy 20-PRB SSB structure may be fully re-used. Only CORESET 0 may need to be punctured.

### Puncturing on CORESET 0 to Support Transmissions Spanning Over 20-PRBs

In legacy, a 20-PRB SSB structure along with a 24-PRB CORESET #0 configuration can be used to transmit on a 5 MHz channel bandwidth having a maximum transmission bandwidth of 25-PRBs. For the Rel-18 WI on “LessThan5 MHz,” a sub-5 MHz use-case will be supported where PHY-channel transmissions will be confined into 20-PRBs, thus CORESET 0 needs to be punctured to fit into 20-PRBs.

It is possible to rely on the minimum available CORESET #0 configuration equal to 24-PRBs, then the puncturing on CORESET #0 can also be a PRB-level puncturing with “k_{SSB}=0” and with “Offset (RBs)” either fixed as to have only 1 puncturing pattern per time-domain structure (i.e., 2 and 3 OFDM symbols) or variable as per legacy (choosing Offset (RBs) between 0, 2, and 4) as to have 3 puncturing patterns per time-domain structure (i.e., 2 and 3 OFDM symbols).

For 5 MHz channel BW, a PRB-level puncturing may be applied on the minimum available legacy CORESET 0's configuration which is equal to 24-PRBs. K_{SSB}=0, such as the n-th Common Resource Block (CRB) in the “Common Resource Block grid” is PRB-level aligned with the reference SSB structure, which in turn sets the location of CORESET 0 using “Offset (RBs)”.

For a 5 MHz channel BW using a 20-PRB CORESET 0 structure, it can be selected between having a single RB-level puncturing pattern for CORESET 0 or three RB-level puncturing patterns for CORESET 0 derived from using all applicable Offset RBs:
Alternative 1: Single RB-level puncturing pattern for CORESET 0 equally applicable for 2 and 3 OFDM symbols: The legacy 24-PRB CORESET 0 structure punctures “0 RBs from bottom and 4 RBs from top” to produce a 20-PRB SSB structure. Only “Offset=0” is used.
Alternative 2: Three RB-level puncturing patterns for CORESET 0 equally applicable for 2 and 3 OFDM symbols: Offset RBs=0: The legacy 24-PRB CORESET 0 structure punctures “0 RBs from bottom and 4 RBs from top” to produce a 20-PRB SSB structure. Offset RBs=2: The legacy 24-PRB CORESET 0 structure punctures “2 RBs from bottom and 2 RBs from top” to produce a 20-PRB SSB structure. Offset RBs=4: The legacy 24-PRB CORESET 0 structure punctures “4 RBs from bottom and 0 RBs from top” to produce a 20-PRB SSB structure.

As discussed above, several candidate recovery techniques have been considered to be applied on the punctured CORESET 0 structure. However, since not even for CORESET 0 structures punctured beyond 20-PRB a recovery technique was expected to be needed, and given that CORESET 0 is not foreseen to be a bottle-neck channel link budget-wise, for 5 MHz channel bandwidth, it can be refrained from introducing/supporting CORESET #0 recovery techniques impacting the technical specification.

CSI-RS/TRS in NR Spectrum “Less than 5 MHZ for FR1”

The Information Element (IE) CSI-FrequencyOccupation may be used to configure the frequency domain occupation of a channel state information measurement resource (e.g. NZP-CSI-RS-Resource, CSI-IM-Resource) (see 3GPP TS 38.331 V17.1.0). Parameters which may be utilized include:
nrofRBs: Number of PRBs across which this CSI resource spans. Only multiples of 4 are allowed. The smallest configurable number is the minimum of 24 and the width of the associated BWP. If the configured value is larger than the width of the corresponding BWP, the UE shall assume that the actual CSI-RS bandwidth is equal to the width of the BWP.
startingRB: PRB where this CSI resource starts in relation to common resource block #0 (CRB #0) on the common resource block grid. Only multiples of 4 are allowed (0, 4, . . . ).

For CSI-RS, the smallest configurable number of RBs is 24. Moreover, the technical specification states that “Only multiples of 4 are allowed. The smallest configurable number is the minimum of 24 and the width of the associated BWP”.

For CSI-RS, the following legacy procedure may be re-used “Only multiples of 4 are allowed. The smallest configurable number is the minimum of 24 and the width of the associated BWP”, where in addition to “24”, the values 20 and 12 are also supported for sub-5 MHz and 3 MHz/sub-3 MHz respectively.

For use cases with less than “5 MHz transmission bandwidth in FR1” there are use-cases with transmissions spanning 20-PRBs, 15-PRBs, and 12-PRBs. The “15-PRBs” use-case is not compliant with “Only multiples of 4 are allowed”. On that matter, if instead 16-PRBs were used then the transmission bandwidth would be exceeded, so 12-PRBs can be used instead.

PUCCH in NR Spectrum “Less than 5 MHZ for FR1”

In relation with PUCCH, it was concluded in 3GPP meeting RAN1 #111 that no enhancements are needed for PUCCH to support transmission bandwidths of <5 MHz for 3 MHz and 5 MHz channel bandwidth, and that a necessity for PUCCH frequency hopping (FH) disabling is to be further studied.

As regards “the necessity for PUCCH FH disabling”. It can be assumed that with more use-cases to be supported with under the scope of “Less Than 5 MHz in FR1” it could be useful to equip the gNodeB with the ability of enabling/disabling Frequency Hopping. For PUCCH to support transmission bandwidths of <5 MHz for 3 MHz and 5 MHz channel bandwidths, Enabling/Disabling Frequency Hopping (FH) may be supported, and the FH configuration to be applied may be indicated via SIB.

PRACH in NR Spectrum “Less than 5 MHZ for FR1”

For PRACH, it was concluded in 3GPP meeting RAN1 #111 thatnNo enhancements are required for PRACH to operate NR on transmission bandwidths of <5 MHz for 3 MHz and 5 MHz channel bandwidth. PRACH formats and configurations not fitting into the transmission bandwidth are not applicable. It was agreed that short PRACH formats with 15 kHz SCS, and long PRACH formats with 1.25 kHz SCS are supported for transmission bandwidths <5 MHz for 3 MHz and 5 MHz channel bandwidth.

### Other Considerations

It can be assumed that the UE could know which RBs are used for SSB transmission after PSS/SSS is detected. Which however does not mean indication signaling is needed. In relation with this, the following observations are noted:

If both the location and number of PRBs to be punctured from the 20-PRBs SSB structure were invariant, then such a fully deterministic scheme won't require an “early indication”. Nonetheless, if more use-cases are to be supported under the scope of “Less Than 5 MHz FR1,” the UE will need to distinguish between the following use-cases:
3 MHz and sub-3 MHz: The UE will need to distinguish whether it is dealing with a 15-PRB SSB structure or a 12-PRB SSB structure. To avoid having to introduce an early indication impacting e.g., PSS/SSS, it can be left up to the sync-raster design to distinguish between the 3 MHz and sub-3 MHz use-cases, and one field in MIB can be used as a confirmation to UE indicating whether transmission/reception will span up to 15-PRBs or up to 12-PRBs.
5 MHz and sub-5 MHz: In this case, both the 5 MHz and sub-5 MHz use-cases make use of a 20-PRB SSB structure, thus one field in MIB can be used to indicate whether transmission/reception will span up to 25-PRBs or up to 20-PRBs.

For 3 MHz channel BW, the distinction between a 15-PRB SSB structure or a 12-PRB SSB structure may be left up to the sync-raster design, and from a RAN1 perspective one field in MIB can be used as a confirmation to UE indicating whether transmissions will span up to 15-PRBs or up to 12-PRBs. The one field in MIB can be obtained from a spare bit in MIB or from the bits associated to fields not applicable in this context (e.g., subCarrierSpacingCommon field).

For 5 MHz channel BW, there is no need to distinguish between different SSB structures since a 20-PRB SSB structure is utilized for the 5 MHz and sub-5 MHz use-cases. From a RAN1 perspective one field in MIB can be used as a confirmation to UE indicating whether transmissions will span over 25-PRBs or over 20-PRBs. The one field in MIB can be obtained from a spare bit in MIB or from the bits associated to fields not applicable for this context (e.g., subCarrierSpacingCommon field).

For the 3 MHz channel bandwidth in band n100 (with maximum channel utilization 15 PRBs) a PBCH transmission bandwidth of 12 PRBs may be considered. It may further be considered that for 3 MHz channel bandwidth, the 12 PRB SSB structure is only supported in band n100.

Some physical channels and signals (e.g., SSB, PDCCH, CSI-RS/TRS, PUCCH, and PRACH) may need changes on the physical layer to operate in spectrum allocations from approximately 3 MHz up to below 5 MHz. This may also apply to NR physical channels and signals not requiring puncturing. For example, the link-budget may need to be considered to avoid any potential “bottle neck” at the moment of operating in “spectrum allocations from approximately 3 MHz up to below 5 MHz.

1-62. (canceled)

63. A method performed by a User Equipment (UE) configured for operation in a wireless communication network, the method comprising:
receiving a Synchronization Signal/Physical Broadcast Channel Block (SSB) from a network node in the wireless communication network; and
locating, based on the SSB, a standard Control Resource Set #0 (CORESET #0) spanning a defined plurality of Physical Resource Blocks (PRBs) and determining a non-punctured subset of PRBs within the standard CORESET #0 to be monitored by the UE for reception of a Physical Downlink Control Channel (PDCCH), the non-punctured subset being within a maximum transmission bandwidth that is associated with the UE and is smaller than a bandwidth spanned by the standard CORESET #0.

64. The method according to claim 63, wherein the standard CORESET #0 is defined for a standard channel bandwidth that is larger than the maximum transmission bandwidth.

65. The method according to claim 63, further comprising the UE monitoring only the non-punctured subset for reception of the PDCCH, and receiving the PDCCH on PRBs in the non-punctured subset.

66. The method according to claim 63, wherein determining the non-punctured subset comprises obtaining, based on the SSB, an index identifying an entry in a predetermined CORESET #0 configuration table, each entry defining a corresponding puncturing pattern for the standard CORESET #0.

67. The method according to claim 66, wherein the corresponding puncturing pattern defined by the entry in the predetermined CORESET #0 configuration table comprises a starting PRB of the non-punctured subset within the standard CORESET #0 and a length in PRBs of the non-punctured subset.

68. The method according to claim 67, wherein the starting PRB is defined relative to a first PRB of the standard CORESET #0.

69. The method according to claim 67, wherein the starting PRB is defined relative to a PRB associated with the SSB, and the length in PRBs is based on a bandwidth indicated together with the SSB.

70. The method according to claim 63, wherein determining the non-punctured subset comprises determining that a defined number of PRBs at a higher-frequency edge of the standard CORESET #0 are punctured, such that the non-punctured subset comprises all or some of the remaining PRBs in the standard CORESET #0.

71. The method according to claim 63, wherein determining the non-punctured subset comprises identifying a puncturing pattern based on a carrier bandwidth location associated with the SSB.

72. The method according to claim 63, wherein determining the non-punctured subset comprises decoding, based on the SSB, a bitmap that indicates, for respective PRB groups of the standard CORESET #0, whether the PRB group is punctured or non-punctured, and identifying the non-punctured subset using the bitmap.

73. The method according to claim 63, wherein determining the non-punctured subset comprises:
determining, based on the SSB, a frequency offset between the SSB and the standard CORESET #0;
identifying, based on the SSB, a number N of contiguous PRBs to be monitored by the UE; and
defining the non-punctured subset as the N contiguous PRBs of the standard CORESET #0 starting at a first non-punctured PRB determined from the frequency offset.

74. The method according to claim 63, wherein determining the non-punctured subset comprises, after receiving the SSB, reading System Information (SI) broadcast by the network node and confirming a puncturing pattern based on one or more of: an offset between a Downlink (DL) carrier used for the UE and a defined frequency reference point, a bandwidth of the DL carrier, and a position of the standard CORESET #0 relative to the defined frequency reference point.

75. The method according to claim 63, wherein determining the non-punctured subset comprises receiving, together with the SSB, an indication of a channel bandwidth configuration of the wireless communication network, and reading a corresponding puncturing pattern from a set of predefined puncturing patterns associated with respective channel bandwidth configurations.

76. A User Equipment (UE) configured for operation in a wireless communication network, the UE comprising:
a communication interface; and
processing circuitry configured to:
receive, via the communication interface, a Synchronization Signal/Physical Broadcast Channel Block (SSB) from a network node in the wireless communication network; and
locate, based on the SSB, a standard Control Resource Set #0 (CORESET #0) spanning a defined plurality of Physical Resource Blocks (PRBs) and determine a non-punctured subset of PRBs within the standard CORESET #0 to be monitored by the UE for reception of a Physical Downlink Control Channel (PDCCH), the non-punctured subset being within a maximum transmission bandwidth that is associated with the UE and is smaller than a bandwidth spanned by the standard CORESET #0.

77. The UE according to claim 76, wherein the processing circuitry is configured to determine the non-punctured subset based on a carrier bandwidth location associated with reception of the SSB.

78. A method performed by a network node configured for operation in a wireless communication network, the method comprising:
transmitting a Synchronization Signal/Physical Broadcast Channel Block (SSB) for reception by a User Equipment (UE), the SSB indicating a location of a standard Control Resource Set #0 (CORESET #0) comprising a plurality of Physical Resource Blocks (PRBs) spanning a bandwidth that is larger than a maximum transmission bandwidth associated with the UE; and
transmitting a Physical Downlink Control Channel (PDCCH) for the UE on PRBs in a non-punctured subset of PRBs within the standard CORESET #0, the non-punctured subset being within the maximum transmission bandwidth.

79. The method according to claim 78, wherein the SSB implicitly or explicitly indicates a puncturing pattern to the UE, the puncturing pattern defining the non-punctured subset and thereby enabling the UE to monitor for the PDCCH on the non-punctured subset.

80. The method according to claim 78, wherein a bandwidth of the SSB corresponds to the maximum transmission bandwidth and wherein a puncturing pattern corresponding to the maximum transmission bandwidth is known to the UE and defines the non-punctured subset.

81. The method according to claim 78, wherein a carrier bandwidth location associated with transmission of the SSB indicates the non-punctured subset.

82. A network node configured for operation in a wireless communication network, the network node comprising:
a communication interface; and
processing circuitry configured to:
transmit, via the communication interface, a Synchronization Signal/Physical Broadcast Channel Block (SSB) for reception by a User Equipment (UE), the SSB indicating a location of a standard Control Resource Set #0 (CORESET #0) that comprises a plurality of Physical Resource Blocks (PRBs) spanning a bandwidth that is larger than a maximum transmission bandwidth associated with the UE; and
transmit, via the communication interface, a Physical Downlink Control Channel (PDCCH) for the UE on PRBs in a non-punctured subset of PRBs within the standard CORESET #0, the non-punctured subset being within the maximum transmission bandwidth.
